(19) United States
(12) Patent Application Publication
(10) Pub. No.: US 2026/0368292 A1
(43) Pub. Date: Nov. 19, 2026

(54) SYSTEMS AND METHODS FOR MULTI-LAYER AUTHENTICATION IN VIRTUAL REALITY PLATFORM USING DYNAMIC AUTHENTICATION CHAIN AND ARTIFICIAL INTELLIGENCE

(71) Applicant: BANK OF AMERICA CORPORATION, Charlotte, NC (US)

(72) Inventors: Manikandan Rajaraman, Chennai (IN); Vijay Kumar Yarabolu, Hyderabad (IN)

(73) Assignee: BANK OF AMERICA CORPORATION, Charlotte, NC (US)

(21) Appl. No.: 19/211,579

(22) Filed: May 19, 2025

(51) Int. Cl. G06F 21/44

(52) U.S. Cl. CPC G06F 21/44

(57) ABSTRACT

Systems, computer program products, and methods are described herein for multi-layer authentication in virtual reality (VR) platform using dynamic authentication chain and artificial intelligence (AI). The present disclosure is configured to receive, using the network interface and via a communication network, a VR application authentication request associated with a VR device, wherein the VR application authentication request comprises an authentication chain block. In addition, the present disclosure is configured to execute a first authentication protocol based on the VR application authentication request, as well as determine an authentication login status based on the first authentication protocol. Furthermore, the present disclosure is configured to execute, using an AI engine, a second authentication protocol based on at least the first authentication protocol to generate a revised authentication chain. The present disclosure is also configured to determine responsive authentication actions based on the second authentication protocol outputs.

### TECHNOLOGICAL FIELD

Example embodiments of the present disclosure relate to multi-layer authentication in virtual reality (VR) platform using dynamic authentication chain and artificial intelligence (AI).

### BACKGROUND

VR applications are increasing in types of use cases and frequency among consumers, professional, and enterprise users. Authentication requirements differ in various VR applications due to the type of data accessed and the functionality of the VR application. For example, VR applications for accessing sensitive, private, or personally identifiable data have different, more complex authentication requirements than VR applications for recreational use. Intelligent VR authentication requires utilizing authentication methods and requirements commensurate with the intended VR application. In addition, due to sensitive data accessible in some VR applications, ensuring secure authentication methods is critical.

Evaluating VR authentication using isolated authentication attempts decreases authentication security by failing to account for previous successful and failed authentication attempts based on individual devices, such as VR headsets, goggles, accessory devices, and other VR-enabled network devices that form a VR platform. Harnessing authentication attempt histories provides additional security layers and allows VR platforms to eliminate false positive authentications to VR applications with highly-sensitive data or to reduce false negative authentication attempts to VR applications that have reduced data security requirements. Historical authentication attempts can inform VR platforms of VR devices or VR application accounts that may be compromised. By utilizing a dynamic authentication chain to track authentication attempt histories, the security of VR applications, VR platforms, and networks is improved, with more accurate results and expedited authentication execution times.

Applicant has identified a number of deficiencies and problems associated with multi-layer authentication in VR platform using dynamic authentication chain and AI. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for dynamic authentication encoding and authentication anomaly detection in network applications using AI models.

The present disclosure comprises a system, method and computer program product comprising a network interface configured to communicate via a communication network; at least one non-transitory storage device comprising computer-readable program code stored thereon; and at least one processing device operably coupled to the network interface and the at least one non-transitory storage device, wherein executing the computer-readable program code is configured to cause the at least one processing device to: receive, using the network interface and via a communication network, a VR application authentication request associated with a VR device, wherein the VR application authentication request comprises an authentication chain block; execute a first authentication protocol based on the VR application authentication request; determine an authentication login status based on the first authentication protocol; execute, using an AI engine, a second authentication protocol based on at least the first authentication protocol to generate an authentication confidence score and a revised authentication chain, wherein the second authentication protocol comprises hashing the authentication chain block based on a subset of an authentication chain and the VR application authentication request to verify the authentication chain block; generating the revised authentication chain by appending the authentication chain block to a subset of the authentication chain; and causing transmission of the revised authentication chain; and determine responsive authentication actions based on the authentication confidence score.

In some embodiments, the first authentication protocol comprises: authorizing, using an authentication server, the VR application authentication request based on an authentication token; updating an authentication status based on authorizing the VR application authentication request; and causing transmission of the VR application authentication request to the AI engine.

In some embodiments, the system, method, and computer program product further comprise: receive, using the network interface and via the communication network, the VR application authentication request; query an authentication state repository using a hash pair key from the authentication chain block to access and retrieve an active authentication chain based on the authentication login status; validate, using the AI engine, one or more hashes in each authentication chain block of an authentication chain link using an active authentication chain via parallel processing; and determine, using the AI engine, an authentication chain status based on validating the one or more hashes.

In some embodiments, the authentication responsive actions comprise: at least one of permitting access to a VR application; transmitting, using the network interface and via the communication network, an authentication alert; triggering multi-factor authentication; and denying access to the VR application.

In some embodiments, the VR application authentication request further comprises: an authentication token, authentication status, authentication chain link, and authentication chain criteria.

In some embodiments, the system, method, and computer program product further comprise: generate a user interface on a display of the VR device; render one or more interactive interface elements within the user interface, wherein the one or more interactive interface elements within the user interface are associated with the VR application authentication request; and receive control signals, using the network interface and via the communication network, from at least one device to modify the one or more interactive interface elements.

In some embodiments, the system, method, and computer program product further comprise: receive at least one historical dataset; train the AI engine based on the at least one historical dataset; receive authentication anomaly data; update the at least one historical dataset with the authentication anomaly data; and retrain the AI engine based on the authentication anomaly data.

In some embodiments, the system, method, and computer program product further comprise: load one or more VR applications and associated VR application metadata into a network environment; generate, using the AI engine, authentication chain criteria for each of the one or more VR applications based on the one or more VR applications and associated VR application metadata; and store the authentication chain criteria in an authentication repository.

In some embodiments, the system, method, and computer program product further comprise: evaluate an authentication chain to determine one or more authentication chain blocks for archival based on authentication chain criteria; generate a copy of the one or more authentication chain blocks for archival and populate the copy of the one or more authentication chain blocks for archival in an archival repository; and remove the one or more authentication chain blocks for archival from the authentication chain and remove node references associated with the one or more authentication chain blocks for archival from the authentication chain.

In some embodiments, the authentication chain block comprises: at least one of a timestamp, authentication block status, VR device data vector, user data vector, geolocation data vector, VR application data vector, historical authentication state hash, hash, and the authentication confidence score.

In some embodiments, the system, method, and computer program product further comprise: transmit, using the network interface and via the communication network, the revised authentication chain to a VR application; and cause transmission of the revised authentication chain from the VR application to the VR device.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrate technical components of an exemplary distributed computing environment for multi-layer authentication in VR platform using dynamic authentication chain and AI, in accordance with an embodiment of the disclosure;

FIG. 2 illustrates an exemplary AI engine subsystem architecture, in accordance with an embodiment of the disclosure;

FIG. 3 illustrates an exemplary generative AI subsystem architecture, in accordance with an embodiment of the disclosure;

FIG. 4 illustrates a process flow for multi-layer authentication in VR platform using dynamic authentication chain and AI, in accordance with an embodiment of the disclosure;

FIG. 5 illustrates a process flow for validating hashes and determining an authentication chain status, in accordance with an embodiment of the disclosure;

FIG. 6 illustrates a process flow for rendering and modifying one or more interactive interface elements, in accordance with an embodiment of the disclosure;

FIG. 7 illustrates a process flow for training and retraining the AI engine, in accordance with an embodiment of the disclosure;

FIG. 8 illustrates a process flow for generating authentication chain criteria, in accordance with an embodiment of the disclosure;

FIG. 9 illustrates a process flow for executing an archiving protocol, in accordance with an embodiment of the disclosure; and

FIG. 10 illustrates a process flow for causing transmission of the revised authentication chain, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, this data may be related to the people who work for the organization, its products or services, the customers, or any other aspect of the operations of the organization. As such, the entity may be any institution, group, association, financial institution, establishment, company, union, authority, or the like, employing information technology resources for processing large amounts of data.

As described herein, a “user” may be an individual associated with an entity. As such, in some embodiments, the user may be an individual having past relationships, current relationships, or potential future relationships with an entity. In some embodiments, the user may be an employee (e.g., an associate, a project manager, an IT specialist, a manager, an administrator, an internal operations analyst, or the like) of the entity or enterprises affiliated with the entity.

As described herein, a “module” may be a self-contained unit of code within an application associated with one or more groups of functions or functionality for executing one or more tasks. In some embodiments, the module may comprise a subcomponent of an application or may comprise the entirety of an application. The module may comprise a data model that establishes how to access, modify, and/or manipulate data within the module. The module may be reusable across various aspects of an application.

As used herein, a “user interface” may be a point of human-computer interaction and communication in a device that allows a user to input information, such as commands or data, into a device, or that allows the device to output information to the user. For example, the user interface may include a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that may be used to identify a user. For example, a system may prompt a user to enter authentication information such as a username, a password, a personal identification number (PIN), a passcode, physical attribute data (e.g., iris recognition, retina scans, fingerprints, finger veins, palm veins, palm prints, digital bone anatomy/structure, and positioning (e.g., distal phalanges, intermediate phalanges, proximal phalanges, and the like)), an answer to a security question, a unique intrinsic user activity (e.g., making a predefined motion with a user device), and/or the like. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources input by the plurality of users within the system. The system may further use its authentication servers to certify the identity of users of the system, such that other users may verify the identity of the certified users. In some embodiments, the entity may certify the identity of the other users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (e.g., rotationally coupled, pivotally coupled, or the like). Furthermore, “operatively coupled” may mean that components may be electronically connected and/or in fluid communication with one another. In some embodiments, a processor and/or processing device may be configured to be operatively coupled to an AI engine and/or assigned to execute computing tasks by the AI engine.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. For purposes of this disclosure, a resource is typically stored in a resource repository-a storage location where one or more resources are organized, stored, and retrieved electronically using a computing device.

As used herein, a “resource transfer,” “resource distribution,” or “resource allocation” may refer to any transactions, activities, or communications between one or more entities, or between the user and the one or more entities. A resource transfer may refer to any distribution of resources such as, but not limited to, VR application account setup, device registration within a network comprising VR application, VR application account revisions, authentication token transactions, data record transmission from a VR application and/or VR device, transmission of authentication chains and/or authentication blocks and/or subsets of authentication chains, transmission of credentials associated with VR applications, or other interactions involving a user's resource or account. Unless specifically limited by the context, a “resource transfer” a “transaction,” “transaction event,” or “point of transaction event” may refer to any activity between a user, a merchant, an entity, or any combination thereof. When discussing that resource transfers or transactions are evaluated, it could mean that the transaction has already occurred, is in the process of occurring or being processed, or that the transaction has yet to be processed/posted by one or more entities associated with a VR device and/or VR application. In some embodiments, a resource transfer or transaction may refer to non-financial activities of the user. In this regard, the transaction may be changing a password, adding new accounts, opening new accounts, adding or modifying account parameters/restrictions, performing/modifying authentication procedures and/or credentials, modifying parameters associated with the one or more distributed network data domains, and/or the like.

Accordingly, the present disclosure is directed to multi-layer authentication in VR platform using dynamic authentication chain and AI. Security requirements and authentication criteria vary for VR applications, notably based on a use case of the VR application and the sensitivity of data accessible through the VR application. Furthermore, relying solely on credentials for VR authentication login requests results in weak authentication security against malicious actors, compromised VR devices, and the like. Also, isolated authentication methods fail to account for authentication attempt histories, which can inform whether a VR device attempting to access a VR application is compromised, is trustworthy, or if additional actions are required. Leveraging authentication history improves authentication attempt outcomes by reducing both false positive and false negative results. Thus, a multi-layered authentication methodology harnessing historical login requests is needed to improve the security, accuracy, and performance of VR application authentication via VR devices.

The present disclosure is configured to utilize an AI engine to determine applicable security criteria for a VR application for use in login requests. The AI engine determines criteria, such as how much authentication history to preserve for future authentication attempts, which reduces short-term and long-term data storage requirements, network latencies, and execution times. A dynamic authentication chain, which may comprise a directed acyclic graph, tracks authentication histories for an associated VR device and VR application to assess each VR application authentication attempt using the previous histories. The dynamic authentication chain may be revised by updating data based on a current VR application authentication request and/or by archiving data to an archival repository, which reduces the size of the authentication chain.

The present disclosure is also configured to receive, using the network interface and via a communication network, a VR application authentication request associated with a virtual VR device, wherein the VR application authentication request comprises an authentication chain block. The authentication chain block is unique to the VR application authentication request. In addition, the present disclosure is configured to execute a first authentication protocol based on the VR application authentication request, as well as determine an authentication login status based on the first authentication protocol. The first authentication protocol may comprise utilization of an authentication server to execute a first layer of authentication. Furthermore, the present disclosure is configured to execute, using an AI engine, a second authentication protocol based on at least the first authentication protocol to generate an authentication confidence score and a revised authentication chain. The authentication confidence score may comprise a numerical rating on a scale to determine, based at least in part on historical authentication requests tracked via the dynamic authentication chain, the security and authenticity of a VR application authentication request. The present disclosure is also configured to determine responsive authentication actions based on the authentication confidence score, such as granting access to the VR application, triggering an alert, requiring one or more additional modes of authentication, and/or denying access to the VR application. By leveraging a dynamic authentication chain and an AI engine, the present disclosure is configured to improve the security of VR application authentications.

What is more, the present disclosure provides a technical solution to a technical problem. As described herein, the technical problem includes multi-layer authentication in VR platform using dynamic authentication chain and AI. The technical solution presented herein allows for allows for dynamic, intelligent, scalable, and efficient multi-layer authentication in VR platform using dynamic authentication chain and AI. In particular, multi-layer authentication in VR platform using dynamic authentication chain and AI is an improvement over existing solutions to the technical challenges, (i) with fewer steps to achieve the solution, thus reducing the amount of computing resources, such as processing resources, storage resources, network resources, and/or the like, that are being used (e.g., utilizing a dynamic archiving protocol to manage the size of the dynamic authentication chain by archiving unnecessary data over time), (ii) providing a more accurate solution to problem, thus reducing the number of resources required to remedy any errors made due to a less accurate solution (e.g., utilizing historical authentication attempts to provide an additional layer of authentication, improving the accuracy of authentication and reducing false positive and false negatives), (iii) removing manual input and waste from the implementation of the solution, thus improving speed and efficiency of the process and conserving computing resources (e.g., by actively archiving unnecessary data from the dynamic authentication chain, computing resources are preserved, as well as leveraging parallel processing to validate data in the dynamic authentication chain), (iv) determining an optimal amount of resources that need to be used to implement the solution, thus reducing network traffic and load on existing computing resources (e.g., by utilizing an AI engine to determine how much authentication history to preserve on the dynamic authentication chain). Furthermore, the technical solution described herein uses a rigorous, computerized process to perform specific tasks and/or activities that were not previously performed. In specific implementations, the technical solution bypasses a series of steps previously implemented, thus further conserving computing resources.

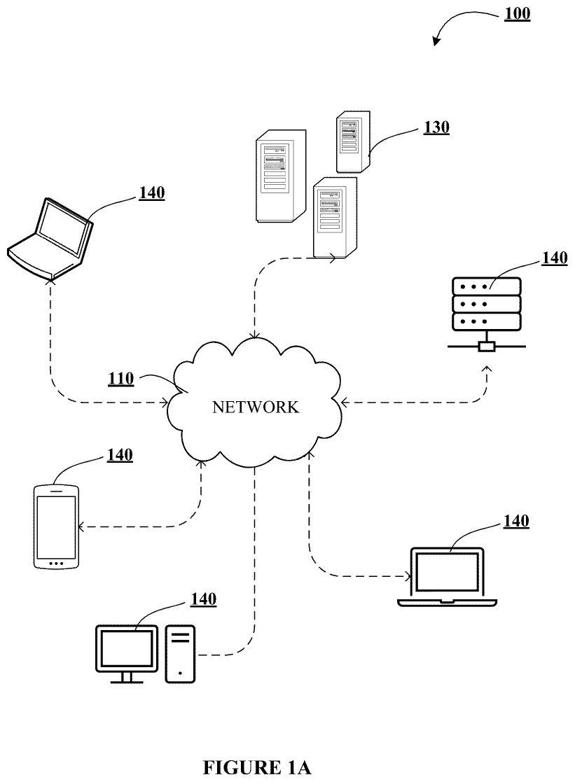

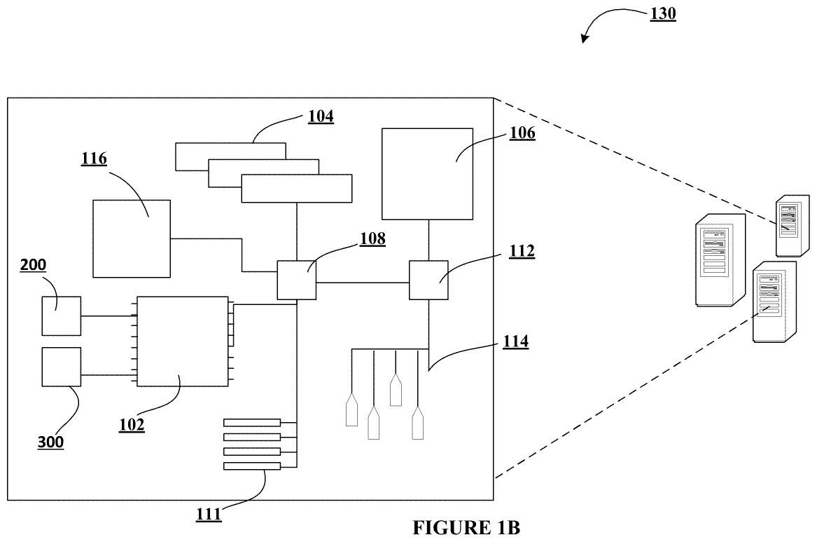

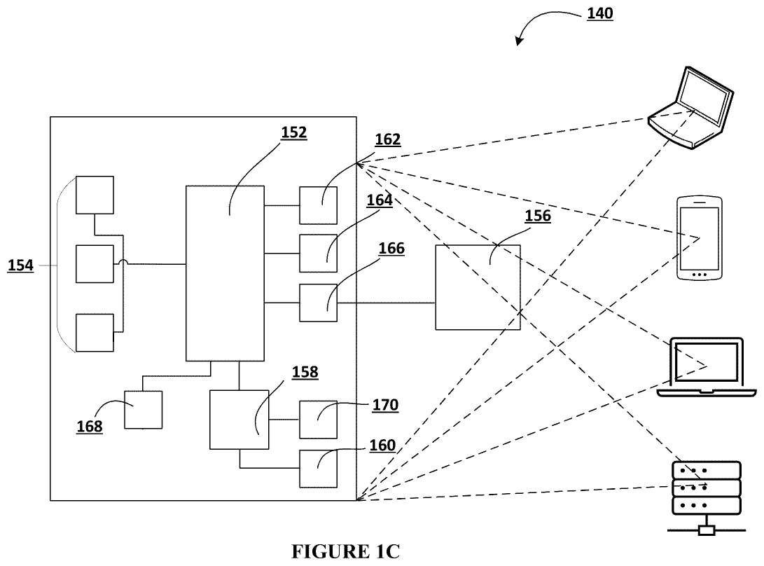

FIGS. 1A-1C illustrate technical components of an exemplary distributed computing environment for multi-layer authentication in VR platform using dynamic authentication chain and AI 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connected to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which may be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 connecting to low-speed bus 114 and storage device 106. Each of the components 102, 104, 106, 108, 112 and 114 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 may be configured to be operatively coupled to an AI engine subsystem architecture 200. The processor 102 may be configured to execute instructions within AI engine subsystem architecture 200, such as within a data acquisition engine 202 (including instructions stored in the database 204), data ingestion engine 210 (including instructions stored in the batch data warehouse 214), data pre-processing engine 216, AI tuning engine 222, and inference engine 236. The processor 102 may be configured to be operatively coupled to a generative AI engine subsystem architecture 300. The processor 102 may be configured to execute instructions within the generative AI engine subsystem architecture 300, such as within a data ingestion engine 302, a data pre-processing engine 304, and a model training engine 306.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product may be tangibly embodied in an information carrier. The computer program product may also contain instructions that, when executed, perform one or more methods, such as those described above. The information carrier may be a non-transitory computer-or machine-readable storage medium, such as the memory 104, the storage device 106, or memory on processor 102.

The high-speed interface 108 manages bandwidth-intensive operations for the system 130, while the low-speed interface/controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, the low-speed interface/controller 112 is coupled to storage device 106 and low-speed bus/expansion port 114. The low-speed bus/expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 166 may comprise appropriate circuitry and may be configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 may be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier may be a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through the communication interface 158, which may include digital signal processing circuitry where necessary. The communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, a GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using an audio codec 162, which may receive spoken information from a user and convert the spoken information to usable digital information. The audio codec 162 may likewise generate audible sound for a user, such as through a speaker (e.g., in a handset of end-point device(s) 140). Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described herein may be realized in digital electronic circuitry, integrated circuitry, specially designed ASICs (application specific integrated circuits), computer hardware, firmware, software, and/or combinations thereof.

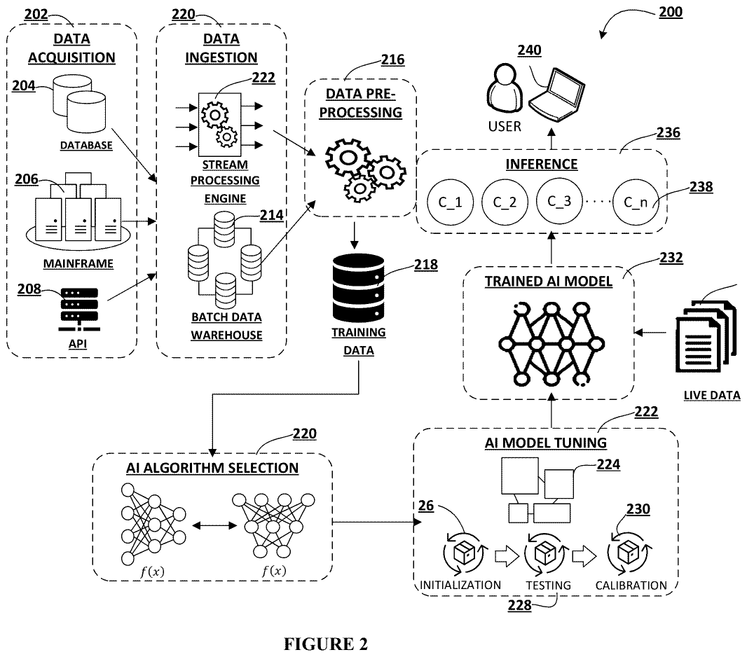

FIG. 2 illustrates an exemplary AI engine subsystem architecture 200, in accordance with an embodiment of the disclosure. The artificial intelligence engine subsystem 200 may include a data acquisition engine 202, data ingestion engine 210, data pre-processing engine 216, AI tuning engine 222, and inference engine 236.

The data acquisition engine 202 may identify various internal and/or external data sources to generate, test, and/or integrate new features for training the artificial intelligence model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including Rational Database Management Systems (RDBMs), other types of databases, Simple Storage System (S3) buckets, Comma Separated Values (CSVs), or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In artificial intelligence, the quality of data and the useful information that can be derived therefrom directly affects the ability of the artificial intelligence model 224 to learn. The data pre-processing engine 216 may implement advanced integration and processing steps needed to prepare the data for artificial intelligence execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of artificial intelligence algorithm being used, this training data 218 may require further enrichment. For example, in supervised learning, the training data is enriched using one or more meaningful and informative labels to provide context so an artificial intelligence model can learn from it. For example, labels might indicate whether a photo contains a bird or car, which words were uttered in an audio recording. Data labeling is required for a variety of use cases including computer vision, natural language processing, and speech recognition. In contrast, unsupervised learning uses unlabeled data to find patterns in the data, such as inferences or clustering of data points.

The AI tuning engine 222 may be used to train an artificial intelligence engine 224 using the training data 218 to make predictions or decisions without explicitly being programmed to do so. The artificial intelligence engine 224 represents what was learned by the selected artificial intelligence algorithm 220 and represents the rules, numbers, and any other algorithm-specific data structures required for classification. Selecting the right artificial intelligence algorithm may depend on a number of different factors, such as the problem statement and the kind of output needed, type and size of the data, the available computational time, number of features and observations in the data, and/or the like. Artificial intelligence algorithms may refer to programs (math and logic) that are configured to self-adjust and perform better as they are exposed to more data. To this extent, artificial intelligence algorithms are capable of adjusting their own parameters, given feedback on previous performance in making prediction about a dataset.

The artificial intelligence algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable artificial intelligence model type. Each of these types of artificial intelligence algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the artificial intelligence model, the AI model tuning engine 222 may repeatedly execute cycles of experimentation 226, testing 228, and tuning 230 to optimize the performance of the artificial intelligence algorithm 220 and refine the results in preparation for deployment of those results for consumption or decision making. To this end, the AI model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained artificial intelligence model 232 is one whose hyperparameters are tuned and model accuracy maximized.

The trained artificial intelligence model 232, similar to any other software application output, can be persisted to storage, file, memory, or application, or looped back into the processing component to be reprocessed. More often, the trained artificial intelligence model 232 is deployed into an existing production environment to make practical business decisions based on live data 234. To this end, the artificial intelligence engine subsystem 200 uses the inference engine 236 to make such decisions. The type of decision-making may depend upon the type of artificial intelligence algorithm used. For example, artificial intelligence models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, artificial intelligence models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, artificial intelligence models that perform regression techniques may use live data 234 to predict or forecast continuous outcomes.

It will be understood that the embodiment of the artificial intelligence engine subsystem 200 illustrated in FIG. 2 is exemplary and that other embodiments may vary. As another example, in some embodiments, the artificial intelligence engine subsystem 200 may include more, fewer, or different components.

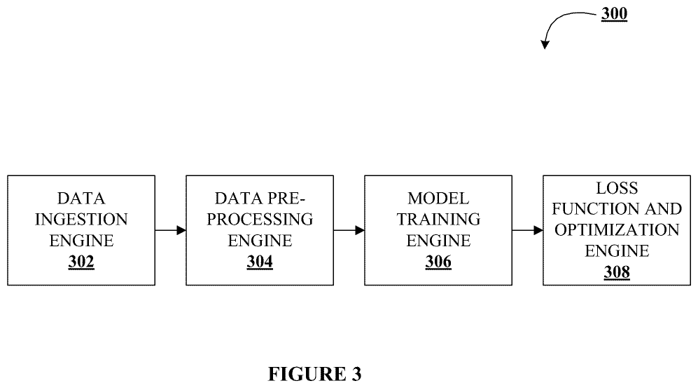

FIG. 3 illustrates an exemplary generative AI subsystem 300, in accordance with an embodiment of the disclosure. The generative AI subsystem 300 may include a data ingestion engine 302, a data pre-processing engine 304, and a model training engine 306. It should be understood that the generative AI subsystem 300 is merely an example, and other embodiments may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 300 should not be considered limiting and may be adapted to various configurations within the scope of the present disclosure.

The data ingestion engine 302 may identify various internal and/or external data sources to generate, test, and/or integrate new features for training the generative AI model. These internal and/or external data sources (e.g., text corpora, web-based text data, document repositories, or decentralized text storage system) may be initial locations where the data originates or where physical information is first digitized. In addition to conventional data sources, the data ingestion engine 302 may support decentralized storage systems, such as blockchain-based data sources, and privacy-preserving methods such as differential privacy. The data ingestion engine 302 may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like.

Depending on the nature of the data, the data ingestion engine 302 may move the data to a destination for storage or further analysis. Typically, the data may be in varying formats as they come from different sources, including RDBMS, other types of databases, S3 buckets, CSVs, or from streams. For a Large Language Model (LLM), text data may originate from sources such as web scrapes, social media, large public text datasets, or the like. Since the data comes from different places, it needs to be cleansed and transformed so that it can be analyzed together with data from other sources. The data may be ingested in real-time, using stream processing, in batches using a batch data warehouse, or a combination of both. Stream processing may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse collects and transfers data in batches according to scheduled intervals, trigger events, or any other logical ordering.

In Machine Learning (ML) and/or AI, the quality of data and the useful information that can be derived therefrom directly affects the ability of the machine learning model to learn. The data pre-processing engine 304 may implement advanced integration and processing steps needed to prepare the data for machine learning execution, including tokenization, text normalization, and removal of irrelevant elements like HTML tags in web-based data, especially for LLM training. This may include modules to perform any upfront, data transformation to consolidate the data into alternate forms by changing the value, structure, or format of the data using generalization, normalization, attribute selection, and aggregation, text-specific transformations such as stemming and lemmatization, data cleaning by filling missing values, smoothing the noisy data, resolving the inconsistency, and removing outliers, and/or any other encoding steps as needed. In some embodiments, the data pre-processing engine 304 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 304 may transform categorical data into numerical formats that are suitable for machine learning algorithms. In this regard, the data pre-processing engine 304 may use techniques such as one-hot encoding or label encoding depending on the nature of the categorical variables and the intended use of the data.

In some embodiments, the data pre-processing engine 304 may also include dimensionality reduction techniques, where the number of input features is reduced while retaining the most relevant information. In this regard, the data pre-processing engine 304 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 304 may then be fed into the model training module 306.

The model training engine 306 may be responsible for training the generative AI models using the pre-processed data from the data pre-processing engine 304. The model training engine 306 may implement various machine learning algorithms, including but not limited to Generative Adversarial Networks (GANs), Variational Autoencoders (VAEs), transformers, diffusion models, or other specialized architectures depending on the specific requirements of the system. These models may be used in a broad range of applications, such as LLMs for text generation, image generation models, video synthesis models, audio generation models, and/or the like. The model training engine 306 may optimize these models by continuously adjusting their internal parameters based on the patterns and relationships identified within the data.

In some embodiments, the model training engine 306 may include a training data handler, which manages the partitioning of the pre-processed data into training, validation, and testing datasets. The training data is used to update the model's parameters, while the validation and testing datasets are reserved to evaluate the model's performance during and after training. The model training engine 306 may support various data-handling strategies, such as cross-validation or random shuffling, to ensure that the model generalizes well and is not overfitting to the training data.

In embodiments involving large language models, the model training engine 306 may utilize transformer-based architectures, such as the Transformer, Bidirectional Encoder Representations from Transformers (BERT), Generative Pre-trained Transformer (GPT), or the like. Transformer models rely on mechanisms like self-attention to capture dependencies between words in a sequence, regardless of their distance from one another. The self-attention mechanism allows the model to weigh the importance of different words in a sentence and establish complex relationships important for understanding context. During training, the model may process vast amounts of text data and learn to predict the next word or token in a sequence based on the input context. This training process allows LLMs to generate coherent text, complete sentences, translate languages, or answer questions based on learned patterns from the data.

The transformer-based LLMs may be trained using autoregressive (e.g., GPT) or masked-language modeling techniques (e.g., BERT). In autoregressive models, the training process may include predicting the next word in a sequence by progressively revealing more context to the model. The model iteratively improves its predictions based on its performance during prior iterations. Masked-language modeling involves masking certain words in a sentence and training the model to correctly predict the masked words based on surrounding context. Both approaches enable LLMs to capture intricate patterns in human language, improving their ability to manage tasks such as summarization, translation, and text generation. Loss functions like cross-entropy loss may be used to optimize the model's performance by comparing predicted tokens with the actual tokens in the dataset to guide the model to minimize prediction errors during training, as described in further detail herein.

In embodiments involving image generation models, the model training engine 306 may utilize transformer-based architectures, such as Vision Transformers (ViTs) or generative adversarial networks (GANs). Vision Transformers rely on self-attention mechanisms to process images as sequences of patches rather than whole images, allowing the model to capture spatial dependencies and patterns across the image. During training, the model may be exposed to large datasets containing diverse image types to learn features like textures, edges, and shapes. The model may then generate or reconstruct images by interpreting these patterns and applying learned spatial relationships. GAN-based models may also be used, where a generator network creates images, and a determinator network evaluates their realism, enabling the model to improve through adversarial training.

Image generation models may employ various training techniques, such as pixel-wise reconstruction or adversarial training, depending on the architecture. Pixel-wise reconstruction methods involve learning to reconstruct an image from its corrupted or downscaled version, optimizing the model to minimize the difference between the predicted and actual pixels (e.g., using mean squared error as the loss function). Adversarial training, often used with GANs, involves iteratively improving the generator network to produce images that are increasingly indistinguishable from real images, based on feedback from the determinator network. These approaches allow the model to capture complex visual features, enabling applications such as image synthesis, enhancement, and style transfer.

For video generation models, the model training engine 306 may employ transformer-based architectures like Video Transformers or GAN-based models specifically designed for handling temporal sequences. Video Transformers use self-attention mechanisms to model dependencies not only between pixels within a single frame but also across frames, allowing them to understand temporal relationships and motion patterns in videos. The model may be trained on large video datasets, enabling it to learn and reproduce dynamic changes and interactions between objects over time. GAN-based video models may incorporate spatiotemporal networks to evaluate the realism of generated video sequences, optimizing the model to produce continuous and coherent frames.

Video generation models may utilize spatial-temporal modeling techniques or adversarial training for generating realistic motion and video sequences. Spatial-temporal modeling involves learning the spatial features within each frame while simultaneously capturing the temporal dependencies between frames, optimizing the model's ability to predict future frames or complete missing sequences. Loss functions like mean squared error or perceptual loss may be applied to reduce discrepancies between predicted and actual frames. Adversarial training, on the other hand, may involve a generator creating video sequences and a determinator evaluating their realism, encouraging the generator to improve by minimizing the discrepancy identified by the determinator. These techniques may enable video generation models to create coherent and realistic sequences, useful in applications such as video synthesis and animation.

In audio generation models, the model training engine 306 may utilize architectures such as Audio Transformers or Recurrent Neural Networks (RNNs) like WaveNet, designed to manage sequential and waveform data. Audio Transformers leverage attention mechanisms to capture relationships between segments of audio, allowing them to model temporal dependencies and predict the next audio sample based on previous context. During training, the model may process large audio datasets containing diverse sound patterns to learn representations of different audio features, such as frequency, amplitude, and harmonics. This training enables the model to generate coherent audio sequences, including speech, music, or ambient sounds, by synthesizing these learned patterns.

Audio generation models may be trained using sequence modeling techniques or autoregressive methods, depending on the architecture. Sequence modeling techniques involve processing and predicting sequences of audio samples, optimizing the model to capture and reproduce temporal dependencies in sound. Autoregressive methods, such as those employed in WaveNet, focus on predicting each audio sample based on prior samples, progressively refining the generated audio sequence over multiple iterations. Loss functions like mean absolute error or cross-entropy loss may be used to minimize the error between predicted and actual audio samples, guiding the model to improve its accuracy. These approaches allow audio generation models to create continuous and realistic audio outputs, applicable in areas such as speech synthesis, music generation, and sound effect creation.

The reconstruction loss ensures that the difference between the original input and the reconstructed output is minimized, guiding the decoder to generate outputs that closely resemble the input data. The second component, KL (Kullback-Liebler) divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models, the model training engine 306, which includes an optimization module 308, may implement various optimization techniques to improve model performance and efficiency. The optimization module 308 is responsible for adjusting the model's internal parameters continuously, using feedback from relevant loss functions tailored to the application (e.g., text, image, audio, or video generation). Techniques such as gradient clipping, learning rate scheduling, and mixed-precision training are applied by the optimization module 308 to stabilize and fine-tune the training process. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float32) for specific calculations, may be used to accelerate training and reduce memory consumption, enabling the model to scale efficiently even when trained on large datasets.

In some embodiments, the model training engine 306 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 306 may also support distributed training across multiple computing nodes, allowing the system to scale its computational resources as needed. Distributed training may involve splitting the generative AI model and data across multiple machines or Graphical Processing Units (GPUs), where each node processes a portion of the data and updates the model in parallel. This is particularly useful for large datasets or models that require significant computational power, such as deep generative models. The model training engine 306 may synchronize the updates across the nodes using techniques like synchronous or asynchronous gradient descent.

Once the generative AI model is trained, the model training engine 306 may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine 306 may also implement transfer learning, where a pre-trained model is fine-tuned on a smaller, domain-specific dataset. This may reduce the amount of time and data required to train a new model, especially in cases where the available data is limited or highly specialized. The model training engine 306 may adjust the parameters of the pre-trained model to better align with the new dataset, while preserving the learned features from the original training.

In embodiments involving LLMs, new output is generated by sampling from the model's probability distribution of tokens, conditioned on the context provided as input. Transformer-based architectures, such as GPT, use an auto-regressive approach where the model predicts the next token in a sequence one step at a time, using previously generated tokens as input for subsequent predictions. The process starts with a prompt or an initial sequence of words, and the model iteratively generates new tokens, forming coherent sentences or paragraphs based on the learned context and language patterns. For masked-language modeling (e.g., BERT), new output may be generated by filling in masked parts of the input sequence, allowing the model to complete sentences or generate variations of the provided text. The generated output can be controlled by adjusting parameters such as heat, which influences the randomness of the token sampling, enabling the generation of diverse or deterministic responses.

In image generation models, such as those using ViTs or GANs, new output is generated by sampling from the learned distribution in the model's latent space. For GANs, the generator network creates an image by transforming random noise vectors into structured image outputs through a series of layers that learn visual features like shapes, textures, and colors. The generated image is then refined through adversarial feedback from the determinator network, which assesses the realism of the generated output. For transformer-based image models, the process may involve reconstructing images by assembling patches based on the learned dependencies between them. Input conditions, such as prompts describing desired features or specific noise vectors, guide the generation process, allowing for the creation of customized images or variations of existing visual styles. These models may also generate images based on style transfer techniques or predefined templates, synthesizing images that align with the characteristics present in the training data.

Video generation models utilize spatiotemporal dependencies to synthesize new video sequences based on the patterns learned during training. In transformer-based architectures, the model may generate video frames sequentially, predicting the next frame based on the input frames and the temporal context established by prior frames. GAN-based models, specifically designed for video synthesis, may sample noise vectors, or use a sequence of frames as input, transforming these into continuous and temporally coherent video outputs through the generator network. The determinator evaluates the temporal consistency and realism of the output, ensuring the generated video mimics the motion dynamics and object interactions present in real-world video data. Such models may also use attention mechanisms to focus on critical elements within each frame and their evolution across time, facilitating realistic scene transitions and motion patterns. The generation process may include user-defined input such as initial frames, motion descriptions, or specific video attributes, providing control over the output.

Audio generation models, including Audio Transformers or autoregressive architectures like WaveNet, generate new audio sequences by predicting audio samples based on learned dependencies in sequential sound data. For autoregressive models, the generation process involves producing each audio sample one at a time, conditioned on previously generated samples, allowing the model to build complex audio patterns such as speech, music, or ambient sounds. The model starts with an initial segment or a random seed and uses its learned parameters to predict and synthesize subsequent samples, constructing a continuous audio waveform. Audio Transformers, on the other hand, may use attention mechanisms to identify important temporal segments within the input audio and synthesize new output based on these learned patterns. The user can control the type of audio generated by providing parameters such as pitch, tempo, or initial sound clips, enabling the model to generate outputs tailored to specific use cases like speech synthesis, music composition, or environmental sound generation.

In some embodiments, generative AI models may also integrate multiple modalities, enabling cross-modal generation where output in one modality influences or conditions the generation in another. For example, a video generation model may use text descriptions as input, synthesizing video content that aligns with the specified narrative or visual scene described. Similarly, image generation models may generate visual representations based on audio inputs, such as generating animations synchronized to musical rhythms or speech patterns. These cross-modal systems typically involve conditional GANs or multi-modal transformers, where the model processes input from one domain (e.g., text or audio) and learns to generate output in another domain (e.g., video or image) by aligning the patterns and dependencies between the different modalities. These models may allow users to generate complex, multimodal content based on combinations of inputs, such as using textual prompts to control the visual and auditory elements of a video.

It will be understood that the embodiment of the generative AI subsystem 300 illustrated in FIG. 3 is exemplary and that other embodiments may vary. The generative AI subsystem 300, as well as its constituent elements, may vary, and modifications or alternative configurations may be implemented without departing from the broader scope of the present disclosure. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

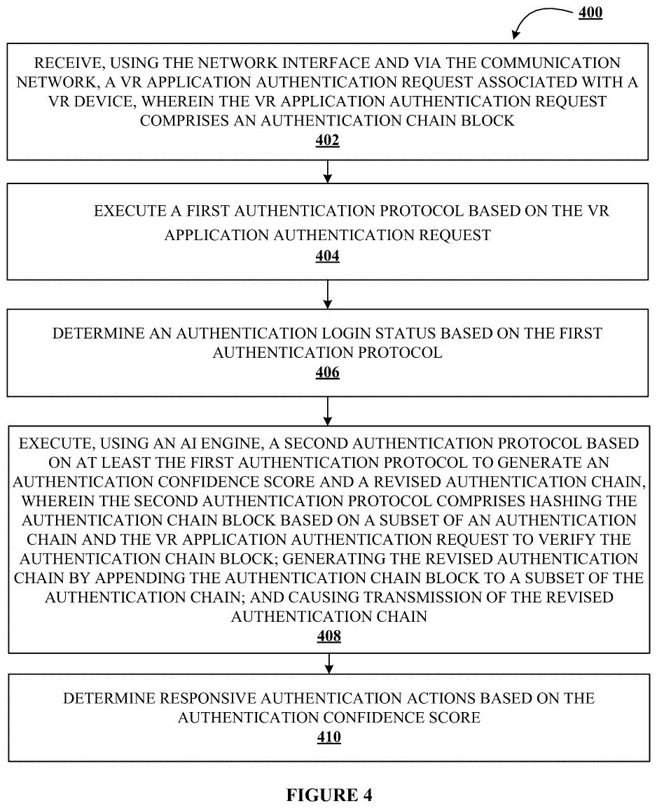

FIG. 4 illustrates a process flow 400 for multi-layer authentication in VR platform using dynamic authentication chain and AI, in accordance with an embodiment of the disclosure. In some embodiments, a system (e.g., similar to one or more of the systems described herein with respect to FIGS. 1A-1C) may perform one or more of the steps of process flow 400. For example, a multi-layer authentication in VR platform using dynamic authentication chain and AI system (e.g., the system 130 described herein with respect to FIGS. 1A-1C) may perform the steps of process flow 400. In some embodiments, an AI engine (e.g., such as the AI engine like that described in FIG. 2) or a generative AI subsystem (e.g., such as the generative AI subsystem described in FIG. 3) may perform some or all of the steps described in process flow 400.

As shown in block 402, the process flow 400 may include the step of receiving, using the network interface and via the communication network, a VR application authentication request associated with a VR device, wherein the VR application authentication request comprises an authentication chain block. In some embodiments, a user may initiate and/or submit a login request seeking to gain access one or more VR applications, such as directly to the VR device and/or to an authentication service via an application programming interface (API). The system may cause the VR device to generate a VR application authentication request based on the login request and/or leverage the VR device to initiate the VR application authentication request by causing transmission of the VR application authentication request to the system, in some embodiments. In some embodiments, a VR application authentication request may comprise credentials for logging into a VR application.

The VR application authentication request may comprise an authentication token, authentication status, authentication chain link, authentication chain criteria, and/or the authentication chain block, in some embodiments. In some embodiments, an authentication token may be generated when processing credentials provided by the user, such as when a user may submit credentials via the VR device. In some embodiments, the credentials may comprise movements executed by the user, captured via sensors and cameras disposed within the VR device and/or associated and connected accessory VR network devices, such as controllers. A token may be generated based upon such inputted credentials, and transmitted via an API to an authentication server for authentication.

In some embodiments, the authentication status may be a status of the VR application authentication request. When a VR application authentication request is first submitted and thereby received by the system, the authentication status may be null and/or undetermined. During processing of the VR application authentication request, the authentication status may be revised at least once, such as to success or fail, based on execution of the VR application authentication request.

In some embodiments, the authentication chain link may comprise at least one subset of the dynamic authentication chain. The authentication chain link may be stored in a repository within the VR device. In some embodiments, the system may execute a syncing process so that the authentication chain link may sync with the dynamic authentication chain to ensure data integrity and consistency. In some embodiments, the authentication chain link may comprise the most recent version of the dynamic authentication chain. In some embodiments, the revised dynamic authentication chain may replace the existing authentication chain link. In some embodiments, the authentication chain link may not comprise data and/or authentication chain blocks stored in an archival repository, which many reduce storage requirements within the VR device.

In some embodiments, the authentication chain criteria may comprise a numerical criterion for how many authentication chain blocks to preserve on the dynamic authentication chain. By way of non-limiting example, and in some embodiments, the authentication chain criteria may comprise one preserved authentication chain block, which may determine that only one authentication chain block with an authentication status of success may be retained in the dynamic authentication chain, wherein other authentication chain blocks may be archived. In some embodiments, an AI engine is pretrained and continuously retrained based on VR application data and metadata to determine the authentication chain criteria for each VR application. VR applications with elevated precision requirements and more complex security requirements for authentication may be associated with a larger authentication chain criteria and VR applications with lowered precision requirements for authentication may be associated with a lower authentication chain criteria and/or less complex security requirements. In some embodiments, the authentication chain criteria may comprise privacy requirements, network access controls, data security requirements, authentication method requirements (a one-time password, a physical attribute authentication, authentication application, multifactor authentication, and/or credentials), and/or the like. In some embodiments, the authentication chain criteria may comprise a minimum character length for credentials, permitted character types for credentials, a required plurality of character types for credentials (such as numerical, alphabetical, special characters, and/or the like), unauthorized character patterns for credentials (such as repeated credentials, repeated characters in a string of credentials, and/or the like), and/or expired credentials.

The authentication chain block may comprise a unique data block associated with the VR application authentication request, In some embodiments. In some embodiments, the authentication chain block may comprise a node in a directed acyclic graph. The authentication chain block may comprise at least one of a timestamp, authentication block status (such as success, failure, and/or null), VR device data vector (which may comprise a VR device identifier and/or hardware and software data of the VR device), user data vector (such as data tracked and gathered by eye-tracking cameras disposed within the VR device, motion and/or depth sensor data disposed within the VR device, eye gaze and pupil dilation data obtained via inward facing sensors disposed within the VR device, and/or voice data obtained via microphone and/or acoustic sensors disposed within the VR device), geolocation data vector (such as geolocation data provided by geotagging via Wi-Fi, geolocation data shared via Bluetooth, and/or IP address), VR application data vector (such as metadata, global unique identifier of the VR application, and/or uniform resource identifier associated with the VR application), historical authentication state hash (such as a hash and/or status associated with one or more authentication chain blocks of the dynamic authentication chain), hash (such as a hash associated with a given authentication chain block), and/or the authentication confidence score (such as a numerical rating on a scale to determine, based at least in part on historical authentication requests tracked via the dynamic authentication chain, the security of a VR application authentication request).

As shown in block 404, the process flow 400 may include the step of executing a first authentication protocol based on the VR application authentication request. In some embodiments, the first authentication protocol may comprise authorizing, using an authentication server, the VR application authentication request based on an authentication token. The authentication server may receive the VR application request via an API and/or using the network interface and via the communication network. The authentication server may receive the VR application request, which may comprise the authentication token, and execute an authorization based on the authentication token using Security Assertion Markup Language, digital certificates, centralized authentication, ticket-based protocol, token-based authentication, Remote Authentication Dial-In User Service protocol, Open Authorization protocol, OpenID Connect, and/or the like.

In some embodiments, the first authentication protocol may comprise updating an authentication status based on authorizing the VR application authentication request. The authentication status of the authentication chain block associated with the VR application authentication request may be revised to success, failure, or undetermined based on the authorization using the authentication token. In some embodiments, an authentication status of success may be associated with a successful first authentication protocol, wherein the authentication server may authenticate the VR application authentication request based on the authentication token. In some embodiments, an authentication status of failure may be associated with an unsuccessful first authentication protocol, wherein the authentication server may fail to authenticate the VR application authentication request based on the authentication token. In some embodiments, an authentication status of undetermined may be associated with an incomplete first authentication protocol, wherein the authentication server may be unable to authenticate the VR application authentication request based on the authentication token due to connectivity issues. In some embodiments, an incomplete first authentication protocol may trigger at least one additional first authentication protocol. A first authentication protocol notification may be transmitted, using the network interface and via the communication network, upon execution of the first authentication protocol, wherein the first authentication protocol notification may comprise the authentication status and data associated with the successful, failed, and/or undetermined first authentication protocol.

In some embodiments, the first authentication protocol may comprise causing transmission of the VR application authentication request to the AI engine. The system may cause transmission of the VR application authentication request to the AI engine by monitoring network data packets associated with execution of the first authentication protocol, In some embodiments. In some embodiments, the VR application authentication request may be transmitted to the AI engine at the same time the first authentication protocol begins, during execution of the first authentication protocol, and/or after completion of updating an authentication status based on authorizing the VR application authentication request.

As shown in block 406, the process flow 400 may include the step of determining an authentication login status based on the first authentication protocol. In some embodiments, the AI engine may evaluate the first authentication protocol to determine the authentication login status, such as by monitoring the success, failure, or undetermined status of the first authentication protocol. In some embodiments, the AI engine may generate and execute a query of a repository associated with the authentication chain block to access the authentication status and/or the AI engine may determine that the authentication login status by matching the authentication login status to the authentication status. By way of non-limiting example, and in some embodiments, when the authentication status is a success, the authentication login status may also be determined to be success. In an additional non-limiting example, and in some embodiments, when the authentication status is a failure, the authentication login status may also be determined to be a failure, and when the authentication status is undetermined, the authentication login status may also be determined to be undetermined.

In some embodiments, the AI engine may determine that the authentication login status may be a failure, even if the authentication status is a success or undetermined, due to a detected anomaly in network data packets comprising authentication data, the VR application authentication request was transmitted via a known-compromised VR device (which may have been flagged via a determined IP address). In some embodiments, an authentication login status alert may be transmitted, using the network interface and via the communication network, to the VR device and/or a network device associated with an account associated with the VR application indicating the authentication login status, any detected anomalies, and/or recommended anomaly remediations, such as disabling a VR application account, blocking network traffic from the VR device, requiring revised credentials to access the VR application, rerouting network traffic transmitted via the VR device, and/or the like.

As shown in block 408, the process flow 400 may include the step of executing, using an AI engine, a second authentication protocol based on at least the first authentication protocol to generate an authentication confidence score and a revised authentication chain, wherein the second authentication protocol comprises hashing the authentication chain block based on a subset of an authentication chain and the VR application authentication request to verify the authentication chain block; generating the revised authentication chain by appending the authentication chain block to a subset of the authentication chain; and causing transmission of the revised authentication chain. In some embodiments, the AI engine may be operatively coupled to at least one processor and/or at least one processing device.

In some embodiments, the second authentication protocol may comprise hashing the authentication chain block based on a subset of an authentication chain and the VR application authentication request to verify the authentication chain block. In some embodiments, hashing may comprise generating a unique identifier for the authentication chain block using a hashing protocol, and the hashing may be executed by the AI engine. Hashing may also allow for later verification of the authentication chain block, or a group of connected authentication chain blocks, as well as to link at least two authentication chain blocks together. The hash may be based on a reference address of the authentication chain block, metadata associated with the authentication chain block, timestamp, authentication block status, VR device data vector, user data vector, geolocation data vector, VR application data vector, historical authentication state hash, hash, and/or the authentication confidence score.

In some embodiments, the subset of the authentication chain may comprise one or more authentication chain blocks from the authentication chain. In some embodiments, the subset of the authentication chain may comprise the authentication chain state link, which may be stored in the VR device. The subset of the authentication chain may comprise at least one authentication chain block of the authentication chain which may be associated with one or more previous VR application authentication requests, such as the immediate preceding VR application authentication requests. In some embodiments, hashing the authentication chain block may comprise verifying the authenticity of the authentication chain block and/or may comprise revising the authentication login status to success, failure, and/or indeterminate.

In some embodiments, the second authentication protocol may comprise generating an authentication confidence score, which may comprise a numerical rating on a scale, such as a range of 0.00 at a lower bound to 1.00 at a higher bound. A lower authentication confidence score may be associated with a lower numerical rating and/or a higher authentication confidence score may be associated with a higher numerical rating. The AI engine may determine the authentication confidence score dynamically based on the authentication chain (including the previous history of VR application authentication requests associated with a VR device to gain access to a particular VR application), authentication chain block, VR application authentication request, detected authentication anomalies (such as security incidents, known compromised VR devices, known compromised VR application accounts, and/or the like), VR application, VR device, and/or authentication chain criteria, in some embodiments. In some embodiments, the authentication confidence score may comprise a rating of confidence in the authenticity of the VR application authentication request associated with a VR device. A history of previous successful VR application authentication requests to gain access to a VR application submitted from the same VR device may result in a higher authentication confidence score, in some embodiments. In some embodiments, a history of previous unsuccessful VR application authentication requests to gain access to a VR application submitted from the same VR device may result in a lower authentication confidence score. The authentication confidence score may be positively or negatively impacted each time a VR application authentication request is submitted by the VR device to gain access to the VR application. By way of non-limiting example, and in some embodiments, an authentication confidence score that may be presently low due to several recently failed VR application authentication requests may be improved when the next VR application authentication request succeeds. In some embodiments, previous authentication confidence scores associated with previous VR application authentication requests may be utilized by the AI engine to generate the authentication confidence score.

In some embodiments, the second authentication protocol may comprise generating a hash of an entire authentication chain, such as the active authentication chain, authentication chain link, and/or authentication chain, to generate a hashed identifier associated with all authentication chain blocks in the authentication chain. By hashing the authentication chain, the system improves security by creating a single-directional, irreversible protocol for enhancing security of confidential security data. The hash of the entire authentication chain may be utilized by the AI engine for verification during future VR application authentication requests.

In some embodiments, the second authentication protocol may comprise generating the revised authentication chain by appending the authentication chain block to a subset of the authentication chain. In some embodiments, appending the authentication chain block to the subset of the authentication chain may comprise adding the authentication chain block as an additional node to the subset of the authentication chain and revising edges between nodes after the addition of this new node. In some embodiments, the revised authentication chain may be stored in a distributed hash table stored via a repository. In some embodiments, the revised authentication chain may replace the authentication chain in the distributed hash table. In some embodiments, the revised authentication chain comprises the subset of the authentication chain and/or the authentication chain appended with the hashed and verified authentication chain block.

The revised authentication chain may comprise one or more authentication chain blocks, which may comprise nodes in a directed acyclic graph and may comprise edges between the nodes. By way of non-limiting example, and in some embodiments, if block6, block5, block4, block3, block2, and block1 are all concurrently nodes, with associated edges, in an authentication chain, such as the revised authentication chain and/or an active authentication chain, which may comprise block6, block3, and block1 with an authentication status of success, and block5, block4, and block2 with an authentication status of failure. Block6 may have a node reference, or edge, to block5, block4, and block3 because block3 is the most recent node with an authentication status of success, and block6 may comprise node references, or edges, to block5 and block4 because these nodes may comprise nodes associated with the two most recently-executed VR application authentication requests immediately prior to the VR application authentication request associated with block6. Block5 may comprise node references, or edges, to block4 and block3, as block3 is the node with the most recent node prior to block5 with an authentication status of success. Block4 may comprise node references, or edges, to block3, block3 may comprise node references, or edges, to block2 and block1, as block1 is the node with the most recent node prior to block3 with an authentication status of success. Block2 may comprise a node reference, or edge, to block1, which is the first node in the authentication chain. Accordingly, each authentication chain block in the revised authentication chain may comprise node references, or edges, to the most recent authentication chain block with an authentication status of success, whether in sequential order or not, and/or the authentication chain block associated with the most recent previous VR application authentication request.

In some embodiments, the second authentication protocol may comprise causing transmission of the revised authentication chain. A network communication may be transmitted, using the network interface and via the communication network, to cause the transmission of the revised authentication chain, in some embodiments. The revised authentication chain may be transmitted, via the network interface and using the communication network, to the VR application, VR device, repository, and/or the like. An Extract, Transform, and Load (ETL) may be utilized to cause transmission of the revised authentication chain and/or transmit the revised authentication chain.

As shown in block 410, the process flow 400 may include the step of determining responsive authentication actions based on the authentication confidence score. In some embodiments, the authentication responsive actions may comprise at least one of permitting access to a VR application; transmitting, using the network interface and via the communication network, an authentication alert; triggering multi-factor authentication; and denying access to the VR application. In some embodiments, the AI engine may determine responsive actions based on the authentication confidence score, authentication login status, first authentication protocol, and/or second authentication protocol.

In some embodiments, the authentication login status may comprise success and the authentication confidence score may exceed a predetermined high authentication confidence score threshold, which may be associated with a low determined security threat, and the VR device may receive full access to the VR application, VR application account, and/or the like.

In some embodiments, the authentication login status may comprise success, the authentication confidence score may exceed a predetermined intermediate authentication confidence score threshold and may not exceed the predetermined high authentication confidence score threshold, which may be associated with an intermediate determined security threat, and while the VR device may receive full access to the VR application, VR application account, and/or the like, a notification may be transmitted, using the network interface and via the communication network, to a second network device associated with the VR application (such as a pre-authorized and/or pre-authenticated second device associated with a VR application user), wherein the notification may comprise an alert comprising a message specifying the VR device gained access to the VR application and/or VR application account, an identifier associated with the VR device, timestamp, and/or the like.

In some embodiments, the authentication login status may comprise success and the authentication confidence score may not exceed the predetermined intermediate authentication confidence score threshold and may not exceed the predetermined high authentication confidence score threshold, which may be associated with a high determined security threat, and may require additional authentication via one or more second authentication methods, such as one-time password, credentials, authentication via cameras and/or sensors in the VR device, authentication application, multi-factor authentication, and/or authentication leveraging a physical electronic device to provide an access code, in order to grant access to the VR application, VR application account, and/or the like. In some embodiments, the AI engine may dynamically select the one or more second authentication methods based on the authentication confidence score and transmit a request, via the network interface and via the communication network, to execute the one or more additional methods of authentication. In some embodiments, if the one or more second authentication methods is successful, then the user and/or VR device may be granted to VR application.

In some embodiments, the authentication login status may a status of failure or undetermined, which may be associated with a severe determined security threat. In some embodiments, the VR application authentication request may be rejected or denied when the authentication login status may not comprise success, the VR device may be flagged, network traffic from the VR device may be rerouted and/or blocked, a security alert may be transmitted, and/or the like.

In some embodiments, one or more additional VP application authentication requests may be submitted by the VR device to establish access to one or more additional VR applications. In some embodiments, one or more additional authentication chains may be generated and/or utilized to track VR application authentication requests associated with the one or more additional VP application authentication requests. By utilizing independent authentication chains for each VP application associated with a VR device, the system ensures that if one authentication chain is compromised due to a security incident, then the security threat to other authentication chains is minimized. At least one additional first authentication protocol, authentication login status determination, second authentication protocol, and determination of responsive authentication actions may be executed based on the one or more additional VP application authentication requests.

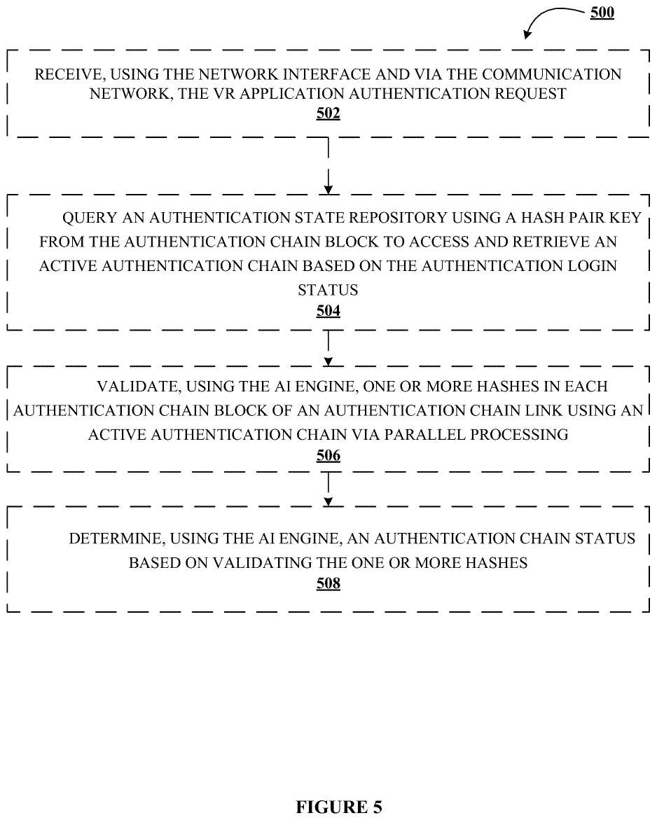

FIG. 5 illustrates a process flow 500 for validating hashes and determining an authentication chain status, in accordance with an embodiment of the disclosure. In some embodiments, a system (e.g., similar to one or more of the systems described herein with respect to FIGS. 1A-1C) may perform one or more of the steps of process flow 500. For example, a multi-layer authentication in VR platform using dynamic authentication chain and AI system (e.g., the system 130 described herein with respect to FIGS. 1A-1C) may perform the steps of process flow 500. In some embodiments, an AI engine (e.g., such as the AI engine like that described in FIG. 2) or a generative AI subsystem (e.g., such as the generative AI subsystem described in FIG. 3) may perform some or all of the steps described in process flow 500.

As shown in block 502, the process flow 500 may include the step of receiving, using the network interface and via the communication network, the VR application authentication request. The VR application authentication request may be transmitted from the VR application, VR device, and/or the like, In some embodiments. In some embodiments, the AI engine may extract data and metadata from the VR application authentication request and may store the extracted data and metadata in an intermediate repository to verify hashes and/or determine an authentication chain status.

As shown in block 504, the process flow 500 may include the step of querying an authentication state repository using a hash pair key from the authentication chain block to access and retrieve an active authentication chain based on the authentication login status. In some embodiments, the authentication state repository may comprise one or more distributed hash tables and/or one or more active authentication chains. By way of non-limiting example, and in some embodiments, the authentication state repository may comprise active authentication chains corresponding to a given VR device and/or VR application, and/or may comprise a dedicated repository for a single active authentication chain.

In some embodiments, a hash pair key from the authentication block is retrieved. The hash pair key may comprise a hashed identifier associated with a VR device and/or VR application. The hash pair key may correspond to an associated VR device and VR application, such that any VR device may be associated with at least one VR application. In some embodiments, the hash pair key may correspond to an exact one-to-one association and/or pairing of a VR device and VR application. The hash pair key may be utilized to query an authentication state repository, which may comprise at least one active authentication chain stored in a distributed hash table. In some embodiments, if an authentication chain block is missing and/or the hash pair key and/or the hash pair key is corrupted and/or compromised, the system may detect the anomaly with the hash pair key and trigger an alert, using the network interface and via the communication network. In some embodiments, the hash key pair may be accessed, evaluated, and/or validated, using the AI engine, prior to executing the query to ensure no anomaly exists with the hash key pair. In some embodiments, if the query using the hash key pair does not result in a retrieval of the active authentication chain, the system may detect the anomaly with the hash pair key and/or authentication state repository and trigger an alert, using the network interface and via the communication network.

In some embodiments, the query may be executed when the authentication login status is success, which may correspond with a successful first authentication protocol. In some embodiments, the query may not be executed when the authentication login status is not a success, such as when the authentication login status comprises failure and/or indeterminate. In some embodiments, the hash key pair may be used as a query to query the authentication state repository, which may comprise at least one distributed hash table, to retrieve and access the active authentication chain. The active authentication chain may comprise the authentication chain, in some embodiments. The active authentication chain may correspond to an authentication chain which has had one or more authentication chain blocks archived, in some embodiments.

As shown in block 506, the process flow 500 may include the step of validating, using the AI engine, one or more hashes in each authentication chain block of an authentication chain link using an active authentication chain via parallel processing. By validating the one or more hashes in each authentication chain block of the active authentication chain, the present disclosure is configured to provide enhanced security during authentication attempts and to detect anomalies during the authentication attempts. In some embodiments, the AI engine may determine the number of authentication chain blocks in the authentication chain link and active authentication and may allocate and/or provision at least one processing device to execute validation of the one or more hashes. In some embodiments, the number of authentication chain blocks may be determined via the authentication chain criteria, which may specify how many authentication chain blocks to retain in an active authentication chain. The validation may occur via parallel processing to ensure dynamic and effective execution, regardless of the size of the active authentication chain and/or authentication chain and/or authentication chain link, based on the number of authentication chain blocks. By way of non-limiting example, and in some embodiments, if there are a plurality of hashes to validate based on a plurality of authentication chain blocks present in the active authentication chain, authentication chain, and/or authentication chain link, the system may assign a corresponding number of processing devices to execute validation of each hash ensure constant runtime execution regardless of the number of hashes to validate. In some embodiments, the AI engine may validate one or more hashes in each authentication chain block of the authentication state link via parallel processing by comparing hash values from the authentication chain blocks from the authentication state link to authentication chain blocks of the active authentication chain.

As shown in block 508, the process flow 500 may include the step of determining, using the AI engine, an authentication chain status based on validating the one or more hashes. In some embodiments, authentication chain blocks in the authentication chain and/or authentication chain link may comprise one or more stored hash vales. In some embodiments, the authentication chain block may comprise one or more stored hash values of this authentication chain block and/or other, previous authentication chain blocks in the authentication chain and/or authentication chain link.

By way of non-limiting example, and in some embodiments, in an authentication chain link and/or authentication chain comprising three authentication chain blocks (in some embodiments, identified as block1, block2, and block3), the block3 may comprise a stored hash value for block3 and/or block2 and/or block1 in a stored authentication chain block hash attribute, which may comprise at least one data repository field for storing hash values of authentication chain blocks in an authentication chain link and/or authentication chain. In some embodiments, there may be an authentication chain block hash attribute for each authentication block in an authentication chain link and/or authentication chain, wherein the authentication chain block hash attribute comprises the stored hash. The AI engine may access the authentication chain block hash attribute for each authentication chain block to compare hash values to corresponding authentication chain blocks in the active authentication chain.

In some embodiments, the AI engine may compare stored hash values for the one or more hashes in the authentication chain link and/or authentication chain to the stored hash values in the active authentication chain to validate the one or more hashes. In some embodiments, the one or more hashes in the active authentication chain match the one or more hashes from the authentication chain link and/or authentication chain, then the AI engine may determine that the authentication chain status is a success. When the one or more hash values from the authentication chain link and/or authentication chain match the one or more hash values in the active authentication chain, the AI engine may determine that the one or more hash values may be authentic, untampered, and/or that the one or more hashes may be validated. In some embodiments, the AI engine may determine that at least one stored hash values may be compromised, and thus may comprise a security incident, if a stored hash value in at least one authentication chain block in the authentication chain link does not match the corresponding hash value for a corresponding authentication chain block in the active authentication chain, which may trigger a security notification transmitted using the network interface and via the communication network.

The AI engine may evaluate the one or more hashes using parallel processing to ensure consistent execution times, providing dynamic, scalable, and efficient validation. Parallel processing enhances the security of the system by quickly executing validations to ensure unauthorized users and/or VR devices associated with a user do not gain access to the VR application. Furthermore, parallel processing allows for scalable processing, as the quantity of authentication chain blocks in a given authentication chain link and/or authentication chain increases based on the authentication chain criteria, execution time is unaffected because each authentication chain block is evaluated and validated simultaneously.

In some embodiments, the AI engine may determine the authentication chain status based on the validation of the one or more hashes. The authentication chain status may comprise success when the AI engine validates the one or more hashes by comparing the one or more hashes from the authentication chain link and/or authentication chain to the one or more hashes in the active authentication chain. An authentication chain status of success may be associated with a successful VR application authentication request, in some embodiments.

The authentication chain status may comprise failure when the AI engine is unable to validate the one or more hashes by comparing the one or more hashes from the authentication chain link and/or authentication chain to the one or more hashes in the active authentication chain, such as when the one or more hashes have been compromised, altered without authorization, and/or comprise incorrect hashes. An authentication chain status of failure may be associated with an unsuccessful VR application authentication request, in some embodiments. In some embodiments, an authentication chain status of failure comprises an authentication anomaly, wherein the AI engine may evaluate the authentication anomaly, generate remediations for the authentication anomaly, and/or transmit the remediations for the authentication anomaly using the network interface and via the communication network. The remediations for the authentication anomaly may comprise revising authentication criteria, increasing network access controls, blocking traffic from the VR device associated with the hash key pair, updating security criteria associated with the VR application, requiring new credentials for the VR application account, and/or the like.

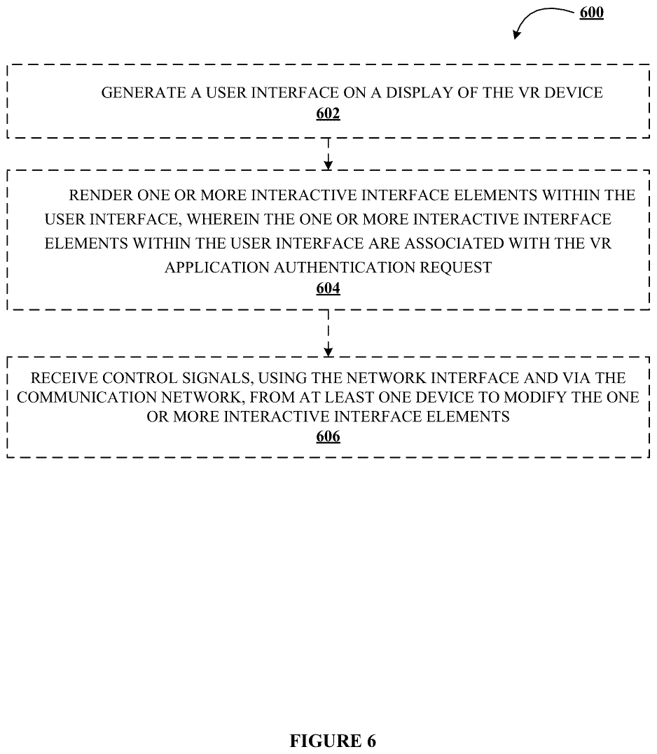

FIG. 6 illustrates a process flow 600 for rendering and modifying one or more interactive interface elements, in accordance with an embodiment of the disclosure. In some embodiments, a system (e.g., similar to one or more of the systems described herein with respect to FIGS. 1A-1C) may perform one or more of the steps of process flow 600. For example, a multi-layer authentication in VR platform using dynamic authentication chain and AI system (e.g., the system 130 described herein with respect to FIGS. 1A-1C) may perform the steps of process flow 600. In some embodiments, an AI engine (e.g., such as the AI engine like that described in FIG. 2) or a generative AI subsystem (e.g., such as the generative AI subsystem described in FIG. 3) may perform some or all of the steps described in process flow 600.

As shown in block 602, the process flow 600 may include the step of generating a user interface on a display of the VR device. In some embodiments, the user interface may be disposed on one or more screens of the VR device, may comprise virtual reality objects, may comprise augmented reality objects, and/or may comprise at least one interface projected virtually via one or more cameras, sensors, and/or the like housed on and/or within the VR device. In some embodiments, the user interface may be generated dynamically upon submission of the VR application authentication request and/or may be generated when the VR device is first powered on.

In some embodiments, the user interface may be disposed within a display device, mixed reality headset, projector system, mobile device, glasses, and/or the like. The user interface may comprise input devices and output devices, including, without limitation, eye tracking cameras, motion sensors, depth sensors, inward-facing sensors to detect eye gaze and pupil dilation in response to generation and/or rendering and re-rendering of interactive user interface elements, virtual buttons, physical buttons, capacitive touch buttons, digital icons and buttons, audio transmitter, audio receiver, microphone, speakers, headphones, telephones, computers, external network device operably coupled to VR device and/or mobile applications, In some embodiments.

As shown in block 604, the process flow 600 may include the step of rendering one or more interactive interface elements within the user interface, wherein the one or more interactive interface elements within the user interface are associated with the VR application authentication request. In some embodiments, the one or more interactive interface elements may comprise menus, icons, digital buttons, digital objects, dashboards, mixed reality objects, and/or channels associated with the VR application authentication request, authentication and/or login landing page associated with the VR application, credentials, VR application, account associated with the VR application, first authentication protocol, second authentication protocol, authentication chain link, authentication chain block, active authentication chain, anomalies associated with the VR application authentication request, anomaly remediations associated with the VR application authentication request, authentication confidence score, authentication login status, authentication status, authentication chain status, and/or the like.

As shown in block 606, the process flow 600 may include the step of receiving control signals, using the network interface and via the communication network, from at least one device to modify the one or more interactive interface elements. In some embodiments, the control signals may be associated with input devices, mobile device, one or more network devices, the interactive interface elements, microphone, audio transmitter, eye tracking cameras, motion sensors, depth sensors, inward-facing sensors to detect eye gaze and pupil dilation in response to generation and/or rendering and re-rendering of interactive user interface elements, and/or the like. By way of non-limiting example, and in some embodiments, a user may interact with the one or more interactive interface elements, which may generate control signals. In some embodiments, the control signals may be associated with the VR application authentication request, authentication and/or login landing page associated with the VR application, credentials, VR application, account associated with the VR application, first authentication protocol, second authentication protocol, authentication chain link, authentication chain block, active authentication chain, anomalies associated with the VR application authentication, authentication confidence score, authentication login status, authentication status, authentication chain status, and/or the like.

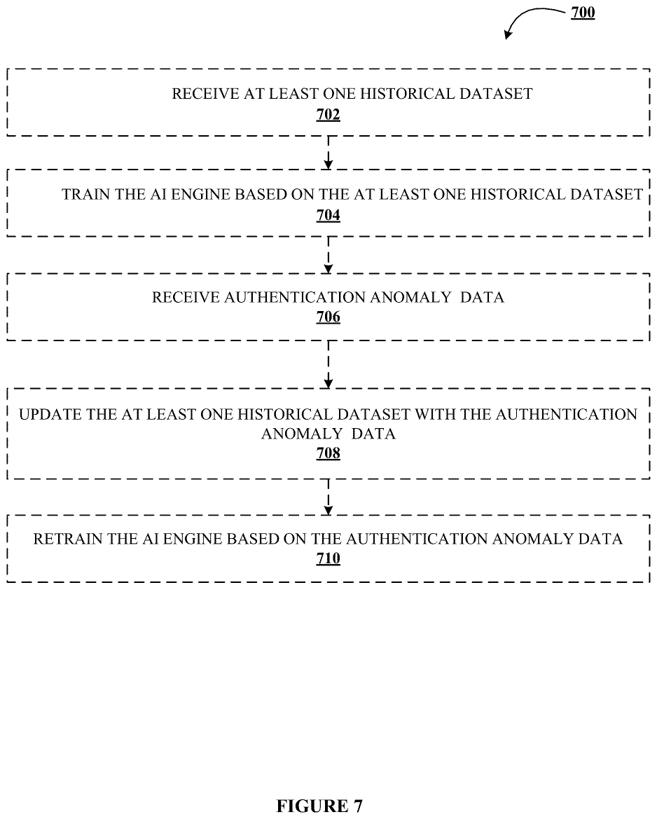

FIG. 7 illustrates a process flow 700 for training and retraining the AI engine, in accordance with an embodiment of the disclosure. In some embodiments, a system (e.g., similar to one or more of the systems described herein with respect to FIGS. 1A-1C) may perform one or more of the steps of process flow 700. For example, a multi-layer authentication in VR platform using dynamic authentication chain and AI system (e.g., the system 130 described herein with respect to FIGS. 1A-1C) may perform the steps of process flow 700. In some embodiments, an AI engine (e.g., such as the AI engine like that described in FIG. 2) or a generative AI subsystem (e.g., such as the generative AI subsystem described in FIG. 3) may perform some or all of the steps described in process flow 700.

As shown in block 702, the process flow 700 may include the step of receiving at least one historical dataset. In some embodiments, the at least one historical dataset may comprise a dataset associated with login data and/or authentication data of one or more VR devices and/or VR application accounts and/or users associated with one or more VR applications. In some embodiments, the at least one historical dataset may comprise a dataset associated with application activity of at least one user logged into at least one VR application using at least one registered VR application account, wherein the application activity may comprise unauthorized actions, unauthenticated access, and/or the like.

In some embodiments, the at least one historical dataset may comprise a dataset associated with metadata of one or more VR applications, which may train the AI engine based on VR applications with variances with authentication criteria and requirements. By way of non-limiting example, and in some embodiments, the metadata may comprise metadata associated with recreational VR applications, educational VR applications, and/or VR applications associated with other personally identifiable data, such as finance records comprising sensitive data. In some embodiments, recreational VR applications may require authentication criteria associated with high recall value, which may be associated with lower security requirements and/or requirements to process requests more quickly, to limit false negative rejections during authentication. In addition, authentication criteria associated with high recall value may comprise reduced active authentication chain requirements, which may comprise authentication chain criteria with reduced authentication history requirements to reduce data storage requirements, expedited execution of VR application authentication requests, and/or a reduction of false negative rejected VR application authentication requests.

Furthermore, in some embodiments, VR applications may require authentication criteria associated with elevated accuracy requirement to limit false positive permitted authentications during VR application authentication requests. To protect confidential, sensitive, and/or personally identifying data in VR applications, the authentication chain criteria may comprise heightened requirements necessitating larger VR application authentication history to ensure greater accuracy during execution of VR application authentication requests. By preserving additional authentication history in the active authentication chain, the system enhances security by evaluating more authentication data when determining to permit access to a given VR device, which enhances security of data stored in a VR application.

In some embodiments, the at least one historical dataset may comprise login data and/or authentication data of one or more VR devices and/or VR application accounts and/or users associated with one or more VR applications, application activity of at least one user logged into at least one VR application using at least one registered VR application account, and/or metadata of one or more VR applications. In some embodiments, the at least one historical dataset may comprise a plurality of datasets, which may comprise a dataset associated with login data and/or authentication data of one or more VR devices and/or VR application accounts and/or users associated with one or more VR applications, a dataset associated with application activity of at least one user logged into at least one VR application using at least one registered VR application account, and/or a dataset associated with metadata of one or more VR applications.

The at least one historical dataset may be stored in an internal data repository, hosted externally by an external network administrator, and/or the like. In some embodiments, the system may collect, compile, and/or aggregate historical data to create the at least one historical dataset and may store the at least one historical dataset in an internal data repository. In such a configuration, the system may access and retrieve the at least one historical dataset each time the AI engine may be trained, wherein the AI engine may comprise an AI engine, AI engine, generative AI engine, AI application, and/or the like. In some embodiments, the system may receive the at least one historical dataset continuously, at set internals, and/or via on-demand request generated by the AI engine, a user, an AI engine training controller, network device, and/or the like. In some embodiments, the system may receive the entire at least one historical dataset. In some embodiments, the system may only receive a subset of data contained within the at least one historical dataset based on training requirements associated with an AI engine training request generated by the system, user, VR device, network device, and/or the like. By training the AI engine on only a subset of the at least one historical dataset based on the most material and/or relevant data, the system may conserve computing resources, minimize energy expenditures, and/or enhance the AI engine performance. In some embodiments, the subset of data may not comprise sensitive data, preventing the inclusion of sensitive data in training the AI engine, which enhances data security and privacy.

As shown in block 704, the process flow 700 may include the step of training the AI engine based on the at least one historical dataset. In some embodiments, the at least one historical dataset comprises historical VR application authentication requests, historical credentials, historical first authentication protocol data, historical first authentication protocols, historical second authentication protocols, historical second authentication data, historical one or more repositories data, historical notifications and/or alerts, historical authentication anomalies, historical authentication anomaly remediations, historical additional VR application authentication requests, historical authentication chains, historical authentication chain blocks, historical authentication chain links, historical active authentication chains, historical revised authentication chains, historical authentication chain criteria, historical control signals, historical at least one historical datasets, historical hash pair keys, historical authentication statuses, historical authentication confidence scores, historical authentication login statuses, historical one or more hashes, historical authentication state repositories, historical authentication tokens, historical VR application metadata, historical archived authentication chain blocks, and/or the like. In some embodiments, the AI engine may be trained on a plurality of at least one historical datasets, wherein the training may be phased in series on each dataset in the plurality of at least one historical dataset. In some embodiments the AI engine may comprise a generative AI model, in which training the generative AI model may comprise ingesting the historical dataset, adjusting parameters in response to generative AI model output, evaluating the model for fine-tuning, and/or deploying the generative AI model.

As shown in block 706, the process flow 700 may include the step of receiving authentication anomaly data. In some embodiments, receiving the authentication anomaly data may comprise receiving network data packets comprising authentication anomaly data. In some embodiments, a data aggregator may collect authentication anomaly data to generate aggregated authentication anomaly data and transmit the aggregated authentication anomaly data via network data packets to the system and/or AI engine. In some embodiments, the data aggregator may pre-process the authentication anomaly data, such as data cleansing, encrypting, and/or executing an ETL process. In some embodiments, the system may process the received network data packets, such as executing decryption, data extraction, and/or the like. In some embodiments authentication anomaly data may comprise data associated with authentication anomalies, authentication anomaly remediations, anomalous network traffic, security incidents, compromised credentials, compromised VR application accounts, compromised VR devices, and/or the like.

As shown in block 708, the process flow 700 may include the step of updating the at least one historical dataset with the authentication anomaly data. In some embodiments, the authentication anomaly data may be attached to the at least one historical dataset. In such a configuration, an ETL process may be executed to transmit the authentication anomaly data dataset to the same data storage repository as the at least one historical dataset.

As shown in block 710, the process flow 700 may include the step of retraining the AI engine based on the authentication anomaly data. The retraining step may be executed via feedback loop for continuous retraining and/or the retraining may occur via internal-based batch jobs, In some embodiments. In some embodiments, the AI engine may refine itself by revising its weights and other such decision factors to improve accuracy, speed, and minimize errors, based on an AI engine training confidence threshold. In some embodiments, the system may determine the AI engine training confidence threshold, and if the AI engine training confidence threshold is below a given confidence threshold (e.g., predetermined, determined via notification from a network device associated with the VR application and/or VR device, and/or dynamically determined by the system), the system may trigger retraining of the AI engine. In some embodiments, if criteria (e.g., criteria for multi-layer authentication in VR platform using dynamic authentication chain and AI) and/or authentication anomaly data are generated and/or received by the system and/or AI engine (hereinafter referred to as “new training factors”), then the system and/or AI engine may trigger in real-time retraining of the AI engine based on the new training factors. By constantly monitoring for new training factors and triggering a responsive real-time retraining, the system provides a technical solution to the challenge of monitoring new training factors and changing network traffic conditions and adjusting the system dynamically.

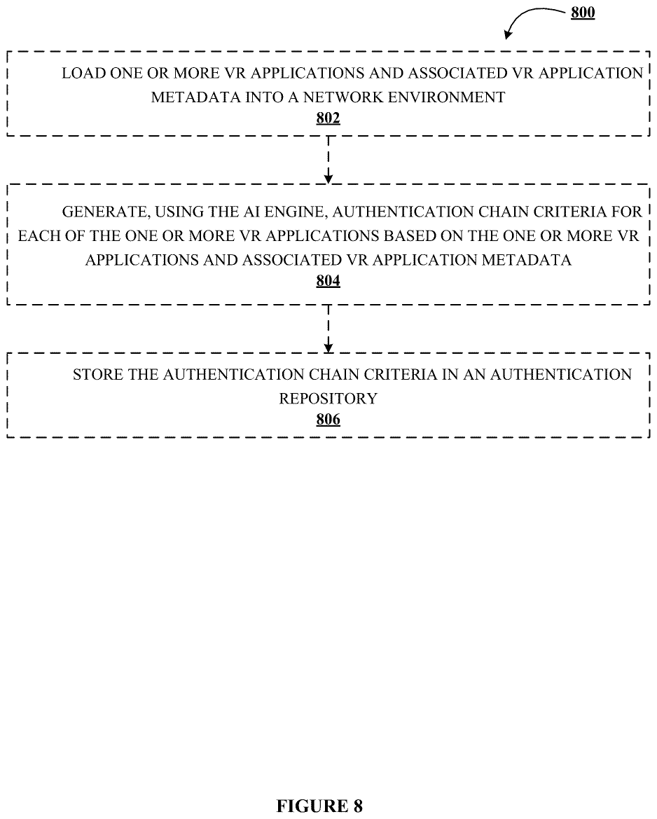

FIG. 8 illustrates a process flow 800 for generating authentication chain criteria, in accordance with an embodiment of the disclosure, in accordance with an embodiment of the disclosure. In some embodiments, a system (e.g., similar to one or more of the systems described herein with respect to FIGS. 1A-1C) may perform one or more of the steps of process flow 800. For example, a multi-layer authentication in VR platform using dynamic authentication chain and AI system (e.g., the system 130 described herein with respect to FIGS. 1A-1C) may perform the steps of process flow 800. In some embodiments, an AI engine (e.g., such as the AI engine like that described in FIG. 2) or a generative AI subsystem (e.g., such as the generative AI subsystem described in FIG. 3) may perform some or all of the steps described in process flow 800.

As shown in block 802, the process flow 800 may include the step of loading one or more VR applications and associated VR application metadata into a network environment. In some embodiments, loading one or more VR applications and associated VR application metadata into a network environment may comprise onboarding a new VR application and associated VR application metadata into a new network environment and/or existing network environment. The onboarding may comprise provisioning computing resources, databases, application servers, domain controllers, and/or authentication servers to the one or more VR applications and associated VR application metadata.

In some embodiments, the one or more VR applications, data associated with the one or more VR applications and associated VR application metadata may be onboarded and/or loaded into the AI engine. Loading into the AI engine may comprise executing a new training cycle by providing data associated with the one or more VR applications and associated VR application metadata to the AI engine to execute an additional training cycle. The AI engine may be continuously retrained using new data, which may comprise authentication anomaly data and/or authentication anomaly remediation data, associated with the one or more VR applications and/or metadata associated with the one or more VR applications following the initial training.

As shown in block 804, the process flow 800 may include the step of generating, using the AI engine, authentication chain criteria for each of the one or more VR applications based on the one or more VR applications and associated VR application metadata. In some embodiments, the authentication chain criteria may comprise a numerical criterion for how many authentication chain blocks to preserve on the dynamic authentication chain. In some embodiments, the authentication chain criteria may specify to only retain a set amount of authentication chain blocks associated with successful and/or unsuccessful VR application authentication requests. By way of non-limiting example, and in some embodiments, the authentication chain criteria may comprise one preserved authentication chain block, which may determine that only one authentication chain block with an authentication status of success may be retained in the active authentication chain, wherein all other authentication chain blocks from the active authentication may be archived. Furthermore, in some embodiments, if the authentication chain criteria may require a single authentication chain block with an authentication status of success to be preserved, authentication chain blocks with an authentication status of failure may or may not be retained. For example, and In some embodiments, at least one previous VR application authentication attempt that did not succeed may be associated with at least one authentication chain block on the active authentication chain with an authentication status of failed, and the last authentication chain block in the active authentication chain may comprise an authentication chain block with an authentication status of success. Accordingly, the active authentication chain may comprise authentication chain blocks with authentication status of success and/or failed, in some embodiments.

In some embodiments, the AI engine may determine the authentication chain criteria based on the one or more VR applications and associated VR application metadata. Authentication criteria that are too weak for certain VR applications results in reduced security, which negatively impacts users, network security, and VR application security. However, authentication criteria that are too stringent for other types of VR applications results in network delays, authentication latencies, and potentially falsely rejected authentication attempts, which may result in poor service outcomes for users.

VR applications with elevated precision requirements for authentication may be associated with a larger authentication chain criteria and VR applications with lowered precision requirements for authentication may be associated with a lower authentication chain criteria. By tailoring authentication criteria to each VR application based on the VR application and its associated metadata, the AI engine customizes how much authentication history to retain to ensure security requirements, security protocols, and computing resource requirements are effectively determined based on the type and use case of each VR application. VR applications that store highly confidential data may require authentication chain criteria that stores a larger quantity of authentication history to generate more accurate authentication confidence scores, in some embodiments. In some embodiments, computing resource and latency requirements for VR applications that store a reduced quantity of confidential data may require to store less authentication history.

In some embodiments, the authentication chain criteria may comprise privacy requirements, network access controls, data security requirements, authentication method requirements (such as a one-time password, a physical attribute authentication, authentication application, multifactor authentication, and/or credentials), and/or the like. In some embodiments, the authentication chain criteria may comprise a minimum character length for credentials, permitted character types for credentials, a required plurality of character types for credentials (such as numerical, alphabetical, special characters, and/or the like), unauthorized character patterns for credentials (such as repeated credentials, repeated characters in a string of credentials, and/or the like), and/or expired credentials.

In some embodiments, the authentication chain criteria may comprise VR device data vector requirements (such as minimum hardware and software requirements), geolocation data vector requirements (such as permitted and unpermitted geolocations), permitted VR device requirements (such as IP addresses that are not flagged for compromises and/or security incidents), and/or VR application data vector requirements (such as version requirements and/or code-patching requirements).

As shown in block 806, the process flow 800 may include the step of storing the authentication chain criteria in an authentication repository. In some embodiments, the authentication chain criteria may be transmitted to the authentication repository via an ETL process. In some embodiments, the authentication chain criteria may be hashed and/or encrypted and stored in a database associated with an authentication server and/or VR application. In some embodiments, the authentication chain criteria may be transmitted, using the network interface and via the communication network, to the authentication repository and/or a network device. In some embodiments, network data packets comprising the authentication chain criteria may be transmitted to the authentication repository.

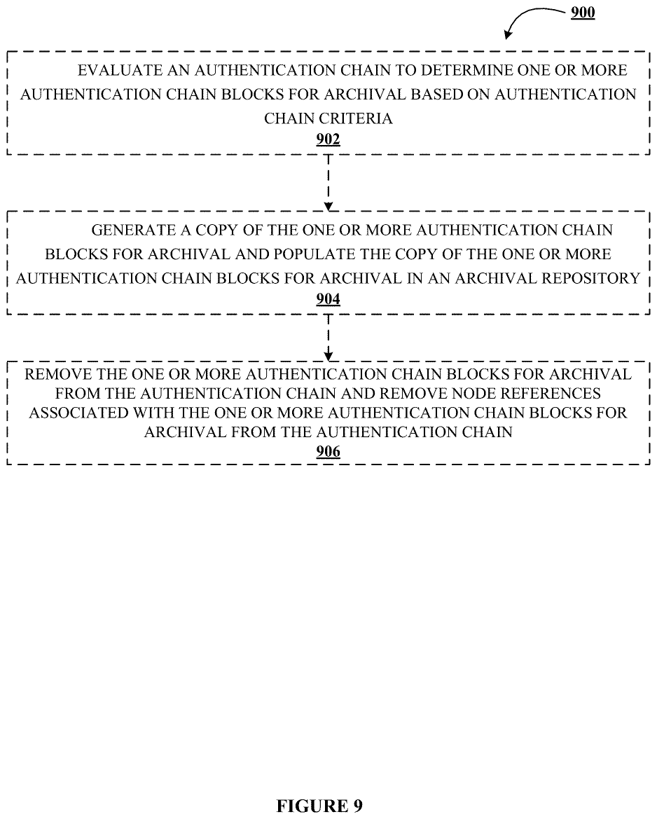

FIG. 9 illustrates a process flow 900 for executing an archiving protocol, in accordance with an embodiment of the disclosure. In some embodiments, a system (e.g., similar to one or more of the systems described herein with respect to FIGS. 1A-1C) may perform one or more of the steps of process flow 900. For example, a multi-layer authentication in VR platform using dynamic authentication chain and AI system (e.g., the system 130 described herein with respect to FIGS. 1A-1C) may perform the steps of process flow 900. In some embodiments, an AI engine (e.g., such as the AI engine like that described in FIG. 2) or a generative AI subsystem (e.g., such as the generative AI subsystem described in FIG. 3) may perform some or all of the steps described in process flow 900.

As shown in block 902, the process flow 900 may include the step of evaluating an authentication chain to determine one or more authentication chain blocks for archival based on authentication chain criteria. In some embodiments, the authentication chain may require archiving if there are one or more authentication chain blocks present in the authentication chain and/or active authentication chain that are deemed unnecessary based on the authentication chain criteria. By way of non-limiting example, and in some embodiments, the authentication criteria may require preserving only one authentication chain block with an authentication status of success in the authentication chain and/or active authentication chain.

In some embodiments, once the authentication chain block associated with the current VR application authentication request is appended to the authentication chain (which may generate the revised authentication chain), there may be one or more authentication chain blocks needed to be archived. By way of non-limiting example, and in some embodiments, once the latest authentication chain block is added with an authentication status of success, and/or the authentication chain criteria comprises one authentication chain block with an authentication status of success, then the system may determine that the revised authentication chain comprises at least two authentication chain blocks with an authentication status of success, and thus must archive the authentication chain block with an earlier timestamp, indicating it is associated with a previous VR application authentication request.

By way of non-limiting example, and in some embodiments, the active authentication chain may comprise three authentication chain blocks, which may comprise block5, block4, and block3, with only block3 comprising an authentication status of success and block5 and block 4 each comprising an authentication status of failure, and the archival repository may comprise two authentication chain blocks, which may comprise block1, which may comprise an authentication status of success, and block2, which may comprise an authentication status of failure, wherein block5 may be the authentication chain block associated with the most recently-executed VR application authentication request. Block5, block4, and block3 may be presently stored in the active authentication chain of the above example because block3 is the most recent authentication chain block with an authentication status of success, and subsequent block5 and block4 are each authentication chain blocks with an authentication status of failure. Authentication chain blocks block2 and block1 may have been archived from the active authentication chain to the archival repository once block3 was added to the authentication chain.

The authentication chain block associated with the current VR authentication application request may comprise block6, which may comprise an authentication status of success. When the authentication chain criteria comprises one authentication chain block with authentication status of success, only one authentication chain block with authentication status of success may be required to be stored in the active authentication chain, with the other authentication chain blocks not preserved in the active authentication chain removed for archival in the archival repository.

Accordingly, the AI engine may determine, based on the authentication chain criteria, that block5, block4, and/or block3 may be archived off the active authentication chain and archived in the archival repository based on block6 being appended to the active authentication chain, in some embodiments. In some embodiments, block6 may be the only authentication chain block to remain in the active authentication chain based on the authentication chain criteria comprising one authentication chain block with authentication status of success.

As shown in block 904, the process flow 900 may include the step of generating a copy of the one or more authentication chain blocks for archival and populate the copy of the one or more authentication chain blocks for archival in an archival repository. In some embodiments, the archival repository may comprise a file system, archival directed acyclic graph, archival chain, database, data lake, and/or the like. In some embodiments, generating a copy of the one or more authentication chain blocks for archival in an archival repository may comprise the AI engine generating a copy of each authentication chain block from the active authentication chain that is determined may be archived and populating the copy in the archival repository. In some embodiments, generating a copy may comprise the AI engine executing a traversal of nodes in a directed acyclic graph and copying data from each node and storing in an intermediate repository and/or staging table, wherein the nodes may comprise authentication chain blocks and edges may comprise connections between the nodes, generating new nodes in the archival repository with and initializing the new nodes with the data stored in the intermediate repository and/or staging table, and/or implementing edges between the new nodes in the archival repository based on the edges between the authentication chain block selected to be archived in the active authentication chain.

As shown in block 906, the process flow 900 may include the step of removing the one or more authentication chain blocks for archival from the authentication chain and removing node references associated with the one or more authentication chain blocks for archival from the authentication chain. In some embodiments, the one or more authentication chain blocks for archival from the authentication chain may be deleted by the AI engine from the active authentication chain. In some embodiments, the node references may comprise edges between authentication chain blocks, which may comprise nodes, indicating a relationship between nodes. Examples of relationships between nodes may comprise node references between nodes to indicate the most recent authentication chain block to have an authentication status of success and/or a node reference to previous nodes with an authentication status of failure, In some embodiments. In some embodiments, an edge may be located between nodes associated with consecutive VR application authentication requests, irrespective of the authentication status of either node.

By way of non-limiting example, and in some embodiments, if block6, block5, block4, block3, block2, and block1 are all concurrently in an authentication chain, such as the active authentication chain, and prior to any archival, with the same authentication statuses set forth in block 902 of process flow 900, block6 may have a node reference to block5, block4, and block3 because block3 is the most recent node with an authentication status of success, and block6 would comprise node references to block5 and block4 because these nodes may comprise nodes associated with the two most recent VR application authentication request prior to the VR application authentication request associated with block6. Block5 may comprise node references to block4 and block3 (because block3 is the first node with an earlier timestamp than block5 with authentication status of success), block4 may comprise node references to block3, block3 may comprise node references to block2 and block1 (because block1 is the first node with an earlier timestamp than block3 with authentication status of success), and block2 may comprise references to block1.

In some embodiments, the node references from where the now-removed one or more authentication chain blocks for archival were the destination node and/or source node may be deleted by the AI engine. In some embodiments, the AI engine may traverse the active authentication chain to identify any orphaned authentication chain blocks following the removal of now-archived authentication chain blocks and/or node references and/or may deleted the orphaned authentication blocks.

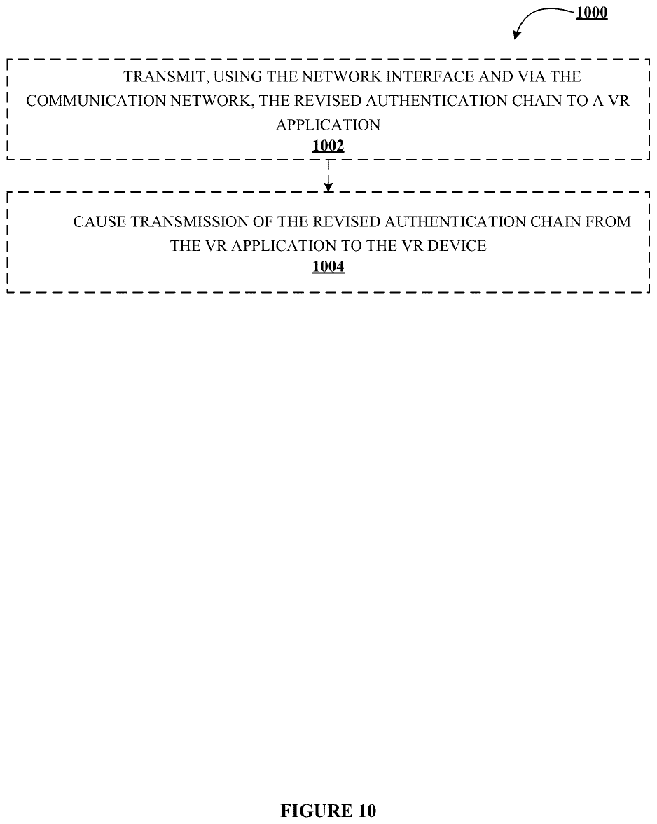

FIG. 10 illustrates a process flow 1000 for causing transmission of the revised authentication chain. In some embodiments, a system (e.g., similar to one or more of the systems described herein with respect to FIGS. 1A-1C) may perform one or more of the steps of process flow 1000. For example, a multi-layer authentication in VR platform using dynamic authentication chain and AI system (e.g., the system 130 described herein with respect to FIGS. 1A-1C) may perform the steps of process flow 1000. In some embodiments, an AI engine (e.g., such as the AI engine like that described in FIG. 2) or a generative AI subsystem (e.g., such as the generative AI subsystem described in FIG. 3) may perform some or all of the steps described in process flow 1000.

As shown in block 1002, the process flow 1000 may include the step of transmitting, using the network interface and via the communication network, the revised authentication chain to a VR application. In some embodiments, the revised authentication chain may be transmitted to the VR application by transmitting network data packets comprising the revised authentication chain. In some embodiments, the VR application may transmit, using the network interface and via the communication network, a confirmation message indicating receipt of the revised authentication chain.

As shown in block 1004, the process flow 1000 may include the step of causing transmission of the revised authentication chain from the VR application to the VR device. In some embodiments, the system may cause transmission of a notification, using the network interface and via the communication network, to the VR application to transmit the revised authentication chain. In some embodiments, the revised authentication chain may be transmitted to the VR device by transmitting network data packets comprising the revised authentication chain. In some embodiments, the VR device may transmit, using the network interface and via the communication network, a confirmation message indicating receipt of the revised authentication chain. By causing transmission of the revised authentication chain to the VR device, the system ensures that the VR device receives the latest version of the authentication chain with an updated authentication chain block. Ensuring transmission of the revised authentication between the system, VR application, and VR device also ensures synchronizing of the authentication chain stored in the VR device, which may comprise the authentication chain link) and active authentication chain, which increases accuracy and security of executed VR application authentication attempts by reducing inaccurate results, such as false negatives and false positives.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for multi-layer authentication in virtual reality (VR) platform using dynamic authentication chain and artificial intelligence (AI), the system comprising:
a network interface configured to communicate via a communication network;
at least one non-transitory storage device comprising computer-readable program code stored thereon; and
at least one processing device operably coupled to the network interface and the at least one non-transitory storage device, wherein executing the computer-readable program code is configured to cause the at least one processing device to:
receive, using the network interface and via the communication network, a VR application authentication request associated with a VR device, wherein the VR application authentication request comprises an authentication chain block;
execute a first authentication protocol based on the VR application authentication request;
determine an authentication login status based on the first authentication protocol;
execute, using an AI engine, a second authentication protocol based on at least the first authentication protocol to generate an authentication confidence score and a revised authentication chain, wherein the second authentication protocol comprises hashing the authentication chain block based on a subset of an authentication chain and the VR application authentication request to verify the authentication chain block; generating the revised authentication chain by appending the authentication chain block to a subset of the authentication chain; and causing transmission of the revised authentication chain; and
determine responsive authentication actions based on the authentication confidence score.

2. The system of claim 1, wherein the first authentication protocol comprises:
authorizing, using an authentication server, the VR application authentication request based on an authentication token; updating an authentication status based on authorizing the VR application authentication request; and causing transmission of the VR application authentication request to the AI engine.

3. The system of claim 1, wherein executing the computer-readable program code is further configured to cause the at least one processing device to:
receive, using the network interface and via the communication network, the VR application authentication request;
query an authentication state repository using a hash pair key from the authentication chain block to access and retrieve an active authentication chain based on the authentication login status;
validate, using the AI engine, one or more hashes in each authentication chain block of an authentication chain link using an active authentication chain via parallel processing; and
determine, using the AI engine, an authentication chain status based on validating the one or more hashes.

4. The system of claim 1, wherein the authentication responsive actions comprise:
at least one of permitting access to a VR application; transmitting, using the network interface and via the communication network, an authentication alert; triggering multi-factor authentication; and denying access to the VR application.

5. The system of claim 1, wherein the VR application authentication request further comprises:
an authentication token, authentication status, authentication chain link, and authentication chain criteria.

6. The system of claim 1, wherein executing the computer-readable program code is further configured to cause the at least one processing device to:
generate a user interface on a display of the VR device;
render one or more interactive interface elements within the user interface, wherein the one or more interactive interface elements within the user interface are associated with the VR application authentication request; and
receive control signals, using the network interface and via the communication network, from at least one device to modify the one or more interactive interface elements.

7. The system of claim 1, wherein executing the computer-readable program code is further configured to cause the at least one processing device to:
receive at least one historical dataset;
train the AI engine based on the at least one historical dataset;
receive authentication anomaly data;
update the at least one historical dataset with the authentication anomaly data; and
retrain the AI engine based on the authentication anomaly data.

8. The system of claim 7, wherein executing the computer-readable program code is further configured to cause the at least one processing device to:
load one or more VR applications and associated VR application metadata into a network environment;
generate, using the AI engine, authentication chain criteria for each of the one or more VR applications based on the one or more VR applications and associated VR application metadata; and
store the authentication chain criteria in an authentication repository.

9. The system of claim 1, wherein executing the computer-readable program code is further configured to cause the at least one processing device to:
evaluate an authentication chain to determine one or more authentication chain blocks for archival based on authentication chain criteria;
generate a copy of the one or more authentication chain blocks for archival and populate the copy of the one or more authentication chain blocks for archival in an archival repository; and
remove the one or more authentication chain blocks for archival from the authentication chain and remove node references associated with the one or more authentication chain blocks for archival from the authentication chain.

10. The system of claim 1, wherein the authentication chain block comprises:
at least one of a timestamp, authentication block status, VR device data vector, user data vector, geolocation data vector, VR application data vector, historical authentication state hash, hash, and the authentication confidence score.

11. The system of claim 1, wherein executing the computer-readable program code is further configured to cause the at least one processing device to:
transmit, using the network interface and via the communication network, the revised authentication chain to a VR application; and
cause transmission of the revised authentication chain from the VR application to the VR device.

12. A computer program product for multi-layer authentication in virtual reality (VR) platform using dynamic authentication chain and artificial intelligence (AI), wherein the computer program product comprises at least one non-transitory computer-readable medium having computer-readable program code portion embodied therein, the computer-readable program code portions which when executed by a processing device are configured to cause a processor to:
receive, using a network interface and via a communication network, a VR application authentication request associated with a VR device, wherein the VR application authentication request comprises an authentication chain block;
execute a first authentication protocol based on the VR application authentication request;
determine an authentication login status based on the first authentication protocol;
execute, using an AI engine, a second authentication protocol based on at least the first authentication protocol to generate an authentication confidence score and a revised authentication chain, wherein the second authentication protocol comprises hashing the authentication chain block based on a subset of an authentication chain and the VR application authentication request to verify the authentication chain block; generating the revised authentication chain by appending the authentication chain block to a subset of the authentication chain; and causing transmission of the revised authentication chain; and
determine responsive authentication actions based on the authentication confidence score.

13. The computer program product of claim 12, wherein the processing device is further configured to:
receive, using the network interface and via the communication network, the VR application authentication request;
query an authentication state repository using a hash pair key from the authentication chain block to access and retrieve an active authentication chain based on the authentication login status;
validate, using the AI engine, one or more hashes in each authentication chain block of an authentication chain link using an active authentication chain via parallel processing; and
determine, using the AI engine, an authentication chain status based on validating the one or more hashes.

14. The computer program product of claim 12, wherein the processing device is further configured to:
evaluate an authentication chain to determine one or more authentication chain blocks for archival based on authentication chain criteria;
generate a copy of the one or more authentication chain blocks for archival and populate the copy of the one or more authentication chain blocks for archival in an archival repository; and
remove the one or more authentication chain blocks for archival from the authentication chain and remove node references associated with the one or more authentication chain blocks for archival from the authentication chain.

15. The computer program product of claim 12, wherein the authentication chain block comprises:
at least one of a timestamp, authentication block status, VR device data vector, user data vector, geolocation data vector, VR application data vector, historical authentication state hash, hash, and the authentication confidence score.

16. A computer-implemented method for multi-layer authentication in virtual reality (VR) platform using dynamic authentication chain and artificial intelligence (AI):
receiving, using a network interface and via a communication network, a VR application authentication request associated with a VR device, wherein the VR application authentication request comprises an authentication chain block;
executing a first authentication protocol based on the VR application authentication request;
determining an authentication login status based on the first authentication protocol;
executing, using an AI engine, a second authentication protocol based on at least the first authentication protocol to generate an authentication confidence score and a revised authentication chain, wherein the second authentication protocol comprises hashing the authentication chain block based on a subset of an authentication chain and the VR application authentication request to verify the authentication chain block;
generating the revised authentication chain by appending the authentication chain block to a subset of the authentication chain; and causing transmission of the revised authentication chain; and
determining responsive authentication actions based on the authentication confidence score.

17. The computer-implemented method of claim 16, wherein computer-implemented method further comprises:
receiving, using the network interface and via the communication network, the VR application authentication request;
querying an authentication state repository using a hash pair key from the authentication chain block to access and retrieving an active authentication chain based on the authentication login status;
validating, using the AI engine, one or more hashes in each authentication chain block of an authentication chain link using an active authentication chain via parallel processing; and
determining, using the AI engine, an authentication chain status based on validating the one or more hashes.

18. The computer-implemented method of claim 16, wherein computer-implemented method further comprises:
evaluating an authentication chain to determine one or more authentication chain blocks for archival based on authentication chain criteria;
generating a copy of the one or more authentication chain blocks for archival and populating the copy of the one or more authentication chain blocks for archival in an archival repository; and
removing the one or more authentication chain blocks for archival from the authentication chain and remove node references associated with the one or more authentication chain blocks for archival from the authentication chain.

19. The computer-implemented method of claim 16, wherein the first authentication protocol comprises:
authorizing, using an authentication server, the VR application authentication request based on an authentication token; updating an authentication status based on authorizing the VR application authentication request; and causing transmission of the VR application authentication request to the AI engine.

20. The computer-implemented method of claim 16, wherein the authentication chain block comprises:
at least one of a timestamp, authentication block status, VR device data vector, user data vector, geolocation data vector, VR application data vector, historical authentication state hash, hash, and the authentication confidence score.
